(19) United States
(12) Patent Application Publication
(10) Pub. No.: US 2011/0069074 A1
(43) Pub. Date: Mar. 24, 2011

(54) Image Display Device And Image Display Method

(75) Inventors: Toshitaka KUMA, Osaka City (JP); Haruo HATANAKA, Kyoto City (JP); Akihiko YAMADA, Daito City (JP)

(73) Assignee: SANYO ELECTRIC CO., LTD., Osaka (JP)

(21) Appl. No.: 12/883,577

(22) Filed: Sep. 16, 2010

(30) Foreign Application Priority Data
Sep. 18, 2009 (JP) 2009-217709
Jul. 28, 2010 (JP) 2010-169704

(51) Int. Cl. G06T 1/00

(52) U.S. Cl. 345/522

(57) ABSTRACT

A switching amount indicating an amount, by which corresponding images are switched, is set based on a switching instruction, which is input by a user. When a displayed corresponding image does not have a close correlation with at least a corresponding image to be displayed next, the corresponding images are switched by a first switching amount, which is determined based on the switching instruction. When the correlation is close, the corresponding images are switched by a second switching amount, which is determined by a method different from that of the first switching amount.

This application is based on Japanese Patent Application No. 2009-217709 filed on Sep. 18, 2009 and No. 2010-169704 filed on Jul. 28, 2010, the contents of which are hereby incorporated by reference.

### BACKGROUND OF THE INVENTION

1. Field of the Invention

The present invention relates to an image display device which displays an image and an image display method.

2. Description of Related Art

In recent years, digital imaging devices, which record taken images (including moving images and still images) as data on a recording medium instead of recording on a film, have been widely spread. This type of imaging device is capable of recording a large amount of image data that is obtained by taking images and capable of deleting any image data item recorded. The device thus allows a user to casually take as many images as he/she likes until a satisfactory image is obtained.

The user uses an image display device attached to the imaging device, typically, a viewer such as a monitor or a photo frame, to reproduce image data (to play moving images or to display still images). The user selects image data to be reproduced with the use of an operation unit constituted of, for example, a touch panel. Some image display devices facilitate the selection process by displaying images corresponding to image data items (hereinafter referred to as corresponding images) such as thumbnail images.

However, clearly displaying a large number of corresponding images at once is difficult because of the limited display screen size of the attached image display device. The user therefore needs to operate the operation unit to switch displayed corresponding images one after another until the corresponding image of desired image data is displayed.

When the number of image data items is large in this case, the user may need to perform the switching many times to find and select desired image data. Specifically, the user may need to go forward (to display the next corresponding image), or go backward (to display the preceding corresponding image), through corresponding images many times. This makes the operation of selecting desired image data laborious, which is a problem.

In the case where there is a plurality of image data items obtained by taking images from the same angle, in the same location, at the same time of day, or the like and the user decides that the desired image data is not among this set of image data items, the user will feel no need to examine the corresponding images of this set of image data items carefully, and is likely to fast forward or fast back (to go forward or backward through many corresponding images in one operation) through the set of image data items in the hope of quickly finding and selecting the desired image data. Then the user may accidentally go past the displayed corresponding image of the desired image data (“forward overshoot” or “backward overshoot”) and take longer to select the desired image data, which is another problem.

To address the problems, an image display device has been proposed which allows a user to select desired image data quickly in just a few operations by displaying reduced images of image data items that resemble a selected image data item in the order of similarity, and subsequently displaying only reduced images of image data items relevant to an image data item that is selected from among the first displayed reduced images.

In another image display device that has been proposed, a representative image data item is determined for each group of a plurality of image data items, and reduced images of the determined image data items are displayed side by side. When a user selects an image data item that is the representative of one group, this image display device displays reduced images of image data items that belong to the same group as the selected image data item.

A drawback of the former image display device is that searching for an image data item to which only a few image data items are similar or relevant is difficult because their reduced images cannot be displayed preferentially. A drawback of the latter image display device is that an image data item is difficult to search for when to which group the image data item belongs is unknown. A user trying to select such an image data item as those has no choice but to search for the image to be selected by going forward or backward through many corresponding images the same way as in conventional devices. The problem of laborious operation and the problem of prolonged image data selection due to “forward overshoot” or “backward overshoot” arise as a result.

### SUMMARY OF THE INVENTION

According to the present invention, there is provided an image display device, including:

a display unit which displays at least one of corresponding images which are in a given order;

an input unit to which a switching instruction is input to switch the at least one corresponding image displayed on the display unit in the given order: and

a switching control unit which switches the at least one corresponding image displayed on the display unit in accordance with the switching instruction,

in which, when the at least one corresponding image displayed on the display unit does not have a close correlation with at least a corresponding image to be displayed next, the switching control unit switches the corresponding images by a first switching amount, which is determined based on the switching instruction, and

in which, when the correlation is close, the switching control unit switches the corresponding images by a second switching amount, which is determined by a method different from that of the first switching amount.

According to the present invention, there is also provided an image display method, including:

a first step of displaying at least one of corresponding images which are in a given order;

a second step of inputting a switching instruction which switches the at least one corresponding image displayed in the first step in the given order; and

a third step of switching the at least one corresponding image displayed in the first step,

in which, when the at least one corresponding image displayed in the first step does not have a close correlation with at least a corresponding image to be displayed next, the corresponding images are switched in the third step by a first switching amount, which is determined based on the switching instruction input in the second step, and

in which, when the correlation is close, the corresponding images are switched in the third step by a second switching amount, which is determined by a method different from that of the first switching amount.

### BRIEF DESCRIPTION OF THE DRAWINGS

FIG. 1 is a block diagram illustrating an example of the structure of an image display device according to an embodiment of the present invention.

FIGS. 2A to 2C are diagrams illustrating an example of how display by a display unit looks in a search for image data to be reproduced.

FIGS. 3A and 3B are graphs showing examples of a basic relation between an instruction amount and a switching amount.

FIG. 4 is a diagram illustrating an example of a feature vector calculation method.

FIG. 5 is a diagram illustrating the example of the feature vector calculation method.

FIGS. 6A and 6B are graphs showing examples of a relation of the instruction amount to the switching amount that is set for the switching of closely correlated corresponding images.

FIG. 7 is a diagram illustrating an example of a set of corresponding images and the order of the corresponding images.

FIGS. 8A to 8D are diagrams illustrating a first display example.

FIGS. 9A to 9C are diagrams illustrating a second display example.

FIGS. 10A to 10D are diagrams illustrating a third display example.

FIGS. 11A to 11C are diagrams illustrating a fourth display example.

FIGS. 12A and 12B are graphs showing examples of a relation between the instruction amount and the switching amount to illustrate a modification example of switching control.

FIG. 13 is a diagram illustrating an example of how corresponding images are switched when various instruction amounts are input.

FIG. 14 is a flow chart illustrating an action of the image display device in which whether the correlation between corresponding images is close or not is determined at the time of switching the corresponding images and then the corresponding images are switched.

FIG. 15 is a flow chart illustrating an action of the image display device in which whether there is a close correlation or not is determined at the time image data is transferred.

FIG. 16 is a flow chart illustrating an action of the image display device in which whether image data that has just been taken has a close correlation or not is determined.

FIG. 17 is a flow chart illustrating a corresponding image switching action that is executed when whether the correlation between corresponding images is close or not is determined in advance.

FIGS. 18A and 18B are diagrams illustrating a first example of a composite corresponding image selection detection action.

FIGS. 19A and 19B are diagrams illustrating a second example of the composite corresponding image selection detection action.

FIGS. 20A to 20C are diagrams illustrating a first example of a post-composite corresponding image selection action.

FIGS. 21A to 21C are diagrams illustrating a third example of the post-composite corresponding image selection action.

FIGS. 22A to 22C are diagrams illustrating a fifth example of the post-composite corresponding image selection action.

FIGS. 23A to 23C are diagrams illustrating a first modification example of the action executed when the selected image is a composite corresponding image.

FIGS. 24A and 24B are diagrams illustrating a third modification example of the action executed when the selected image is a composite corresponding image.

FIGS. 25A and 25B are graphs showing other examples of the basic relation between the instruction amount and the switching amount.

FIG. 26 is a diagram illustrating another example of how display by the display unit looks in a search for image data to be reproduced.

### DETAILED DESCRIPTION OF PREFERRED EMBODIMENT

The significance and effects of the present invention are clarified by the following description of an embodiment. However, the embodiment given below is merely one of possible embodiments of the present invention, and terms describing the present invention and its components are not limited to the meaning written in the following embodiment.

<<Overview of an Image Display Device>>

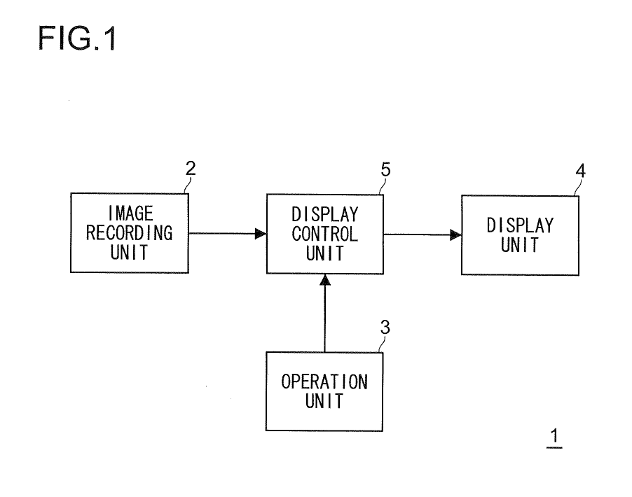

An embodiment of the present invention is described below with reference to the drawings. First, an overview of an image display device according to the present invention is given with reference to FIG. 1. FIG. 1 is a block diagram illustrating an example of the structure of the image display device according to the embodiment of the present invention.

As illustrated in FIG. 1, an image display device 1 includes an image recording unit 2, which records image data, an operation unit 3, to which an instruction from a user is input, a display unit 4, which displays images, and a display control unit 5, which reads necessary information out of the image recording unit 2 in accordance with various instructions input from the user via the operation unit 3, and which controls images displayed by the display unit 4.

The image display device 1 causes the user to select an image data item to be reproduced from among image data items recorded in the image recording unit 2. To this end, the display control unit 5 causes the display unit 4 to display at least one corresponding image of an image data item (for example, a thumbnail image attached as one of the contents of the image data item, or an image obtained by the display control unit 5 by adjusting the image data item (e.g., a reduced image of a still image or a reduced image of one frame contained in a moving image)).

Image data items recorded in the image recording unit 2 are in a given order. The given order can be any order, for example, the order of image taking date/time, the order of image taking, the order of image data names, the order of file formats, an arbitrary order set by the user, or a combination of those orders. A corresponding image which corresponds to an image data item can be interpreted as occupying the same place in the order as its image data item. In addition to the image data item's place in the order, the corresponding image is interpreted as having various relations its image data item has (for example, a correlation and a category). The following description is simplified by assuming that a corresponding image occupies the same place in the order and has the same relations as its image data item.

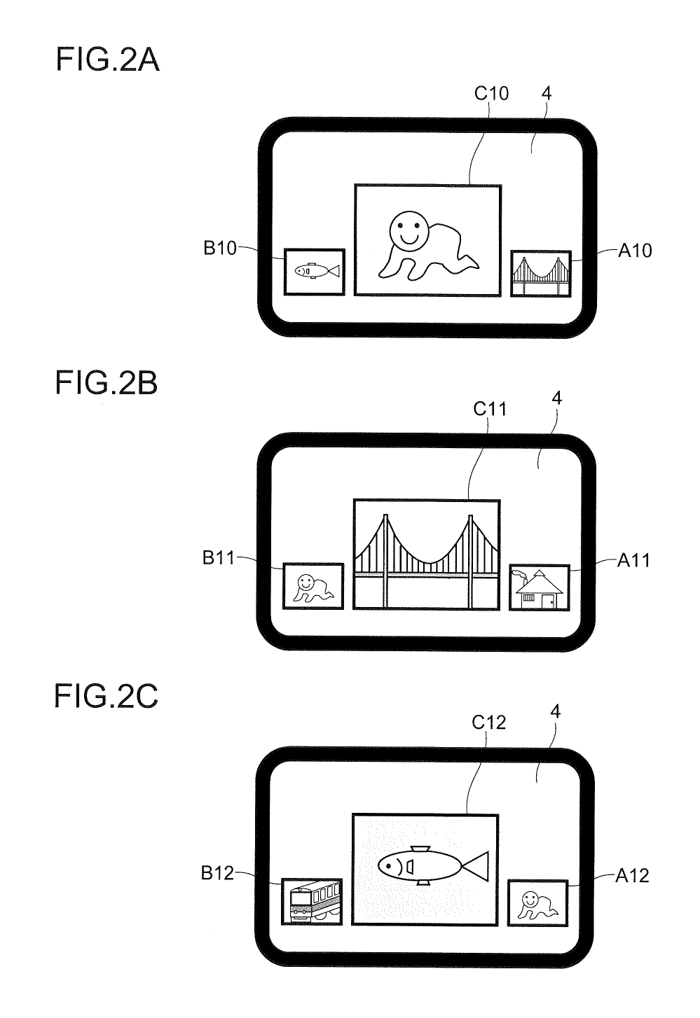

In a search for image data to be reproduced, display by the display unit 4 looks, for example, as illustrated in FIGS. 2A to 2C. FIGS. 2A to 2C are diagrams illustrating an example of how display by the display unit 4 looks in a search for image data to be reproduced.

As illustrated in FIG. 2A, the display unit 4 in this example displays three corresponding images, that is, a reproduction candidate image C10, a preceding candidate image B10, and a next candidate image A10. Specifically, the reproduction candidate image C10 is displayed substantially at the center of the display unit 4, with the preceding candidate image B10 and the next candidate image A10 displayed on the left and right side thereof. The corresponding images are successive to one another in the order of the preceding candidate image B10, the reproduction candidate image C10, and the next candidate image A10.

When the user operates the operation unit 3 to input a “selection instruction,” an image data item to which the reproduction candidate image C10 corresponds is reproduced. As illustrated in FIG. 2B, when the user operates the operation unit 3 to input an instruction for “moving the reproduction candidate image forward by one image,” the next candidate image A10 turns into a reproduction candidate image C11, the reproduction candidate image C10 turns into a preceding candidate image B11, and a corresponding image that immediately follows the next candidate image A10 in the order turns into a next candidate image A11. As illustrated in FIG. 2C, when the user operates the operation unit 3 to input an instruction for “moving the reproduction candidate image backward by one image,” the preceding candidate image B10 turns into a reproduction candidate image C12, the reproduction candidate image C10 turns into a next candidate image A12, and a corresponding image that precedes the preceding candidate image A10 in the order turns into a preceding candidate image B12.

The reproduction candidate images C10 to C12 are preferred to be distinguishable from other corresponding images such as the preceding candidate images B10 to B12 and the next candidate images A10 to A12. In the example of FIGS. 2A to 2C, the display control unit 5 adjusts the size of each corresponding image such that the reproduction candidate images C10 to C12 are displayed larger than the other corresponding images A10 to A12 and B10 to B12. In addition to this (or instead of this), other methods may be employed to differentiate the reproduction candidate images C10 to C12, including giving the displayed reproduction candidate images C10 to C12 an outer frame different from that of the other corresponding images A10 to A12 and B10 to B12.

The image display device 1 can be a part of some device (for example, the image display device 1 can be a monitor of an imaging device). The components illustrated in FIG. 1 can therefore be put to other uses as well. A corresponding image is not limited to a thumbnail image attached to image data or a reduced image, and may be an image of characters, an icon, or a combination thereof.

In FIGS. 2A to 2C, the image data items reproduced are ones associated with images that are the reproduction candidate images C10 to C12 upon input of a “selection instruction”. In addition to this (or instead of this), the image data item reproduced may be one associated with an arbitrary corresponding image specified by the user from among displayed corresponding images. In the case where the operation unit 3 is, for example, a touch panel, the user may touch (tap) a place where a desired corresponding image is displayed to thereby input a selection instruction for selecting this corresponding image. In the case where the operation unit 3 is, for example, a tracking ball or a set of keys (including keys displayed on a touch panel, which is true also in the following description), the user may specify a desired corresponding image via the operation unit 3 and simultaneously press a given key to thereby input a selection instruction for selecting this corresponding image. The user may instead press a given key to input a selection instruction for selecting a corresponding image that is the reproduction candidate image C10, C11, or C12 at the time the key is pressed.

While FIGS. 2A to 2C illustrate a case where the display unit 4 displays three corresponding images at a time, the number of corresponding images displayed may be one, two, or equal to or larger than four.

<<Switching Control of Corresponding Images>>

The description given next with reference to the drawings is about details of corresponding image switching control in a search for image data to be reproduced.

<Switching Control: Basics>

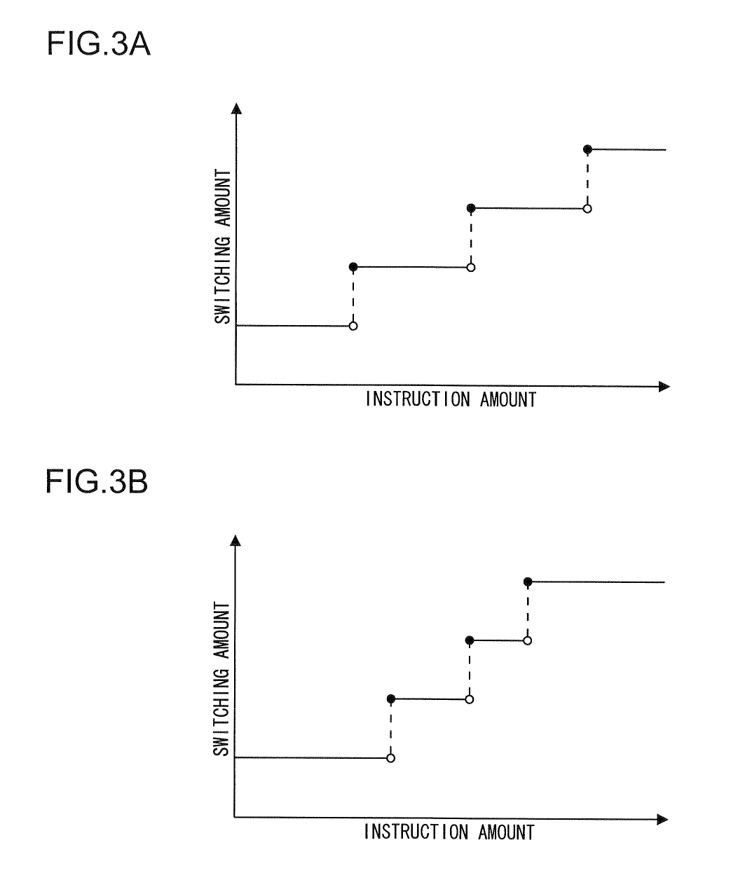

The basics of switching control are described first with reference to the drawings. FIGS. 3A and 3B are graphs showing examples of a basic relation between an instruction amount and a switching amount.

The “instruction amount” is the signal value of a switching instruction which is input to the display control unit 5 by the user by operating the operation unit 3. In principle, the instruction amount increases as the amount of the user's operation of the operation unit 3 at a time (or per unit time) is increased or the length of operation at a time is prolonged. For example, in the case where the operation unit 3 is a touch panel, the instruction amount is larger when the user slides a finger, a stylus, or the like on the touch panel (strokes the touch panel) in one direction for a longer distance, or at a higher speed, at a time. To give another example, in the case where the operation unit 3 is a set of keys, the instruction amount is larger when the user keeps pressing one key for a longer period of time. In still another example where the operation unit 3 is a tracking ball, the instruction amount is larger when the user causes the tracking ball to rotate in one direction faster. Those are merely examples and the instruction amount can be set in any way.

The “switching amount” is a value set by the display control unit 5 based on the instruction amount which is input from the operation unit 3, and indicates the amount of corresponding images displayed on the display unit 4 that are to be switched. To give a concrete example, the switching amount can be defined as the number of corresponding images that are switched per unit action or per unit time. The following description is made concrete by defining the switching amount as the number of corresponding images that are switched in one switching action and as an integer (which means that the screen scrolls forward or backward through corresponding images on an image basis). Defined as this, the switching amount in the switch from FIG. 2A to FIG. 2B is one.

The graphs of FIGS. 3A and 3B each have an axis of abscissa that represents the instruction amount per one operation or per unit time and an axis of ordinate that represents the switching amount. The switching amount increases in a stepped manner as the instruction amount increases. However, in the graph of FIG. 3A, the increment in instruction amount necessary to increase the switching amount by one step is regular irrespective of how large or small the instruction amount is, whereas in the graph of FIG. 3B, the increment in instruction amount necessary to increase the switching amount by one step grows smaller as the instruction amount increases. Another difference between FIGS. 3A and 3B is that, while the switching amount in the graph of FIG. 3A does not have an upper limit, the switching amount in the graph of FIG. 3B has an upper limit and becomes constant after the instruction amount reaches a certain value.

FIGS. 3A and 3B are merely examples, and the relation between the instruction amount and the switching amount can be other than the basic relation shown in FIGS. 3A and 3B. For instance, the switching amount in the graph of FIG. 3A may have an upper limit, and the switching amount in the graph of FIG. 3B may not have an upper limit.

The image display device 1 may switch corresponding images such that the user can view not only the display before and after the switching but also the process of the switching (the dynamic sequence of corresponding images being switched to go forward or backward). This structure allows the user to recognize the specifics of the switching with ease, and therefore is preferred.

<Switching Control: Corresponding Images Having a Close Correlation>

Corresponding images are switched, in principle, by a switching amount set in accordance with a basic relation as shown in FIG. 3A or 3B. An exception is when corresponding images to be switched to go forward or backward are those having a close correlation (for example, image data items whose degree of correlation, which is described later, is equal to or larger than a threshold). Then the image display device 1 of this embodiment sets a switching amount that does not satisfy the basic relation described above. A description is given below with reference to the drawings on switching control that is executed when closely correlated corresponding images are switched.

[Calculation of the Degree of Correlation]

An example of how to calculate the degree of correlation is described first. The degree of correlation is calculated by comparing various types of information on a plurality of image data items. The degree of correlation may be calculated from two image data items that are consecutive in the order, or from three or more image data items that are consecutive in the order.

The calculation of the degree of correlation can use various types of information on image data, including the image taking date/time and image taking location of image data, the degree of similarity between images composed from image data items (for example, a still image or one frame contained in a moving image, which hereinafter may simply be referred to as image), settings set by the user, and a result of comprehensively weighing those points. To give a concrete example, the degree of correlation is higher when compared image data items have image taking dates/times closer to each other, have image taking locations closer to each other, and create images more similar to each other (e.g., images have a greater degree of similarity to each other).

In the case where the degree of correlation is calculated from the image taking date/time of image data, the image taking date/time used for the calculation is, for example, one that is recorded as part of image data when an image is taken. The calculation of the degree of correlation may be weighted such that compared image data items have a particularly high degree of correlation when the time difference between the image taking dates/times of the image data items is smaller than a reference time, which is a given length of time.

In the case where the degree of correlation is calculated from the location of image taking, the image taking location used for the calculation is, for example, one recorded as part of image data when an image is taken by an imaging device equipped with a global positioning system (GPS). The calculation of the degree of correlation may be weighted such that compared image data items have a particularly high degree of correlation when the distance difference between the image taking locations of the image data items is smaller than a reference distance, which is a given distance.

Methods of calculating the degree of similarity between images are described below. The degree of similarity between images can be calculated from various aspects. Three different methods of calculating the degree of similarity which are referred to as first method, second method, and third method are discussed in the following description. The calculation of the degree of similarity may use any of the first to third methods or a combination thereof.

Described first as the first method is a method of calculating the degree of similarity based on the number of people in each image. In this method of calculating the degree of similarity, the number of people is calculated for each compared image by performing face detection on each image and counting the number of faces detected in the image. When the number of people calculated for one image and the number of people calculated for another image are substantially equal to each other, the degree of similarity between the images is set high. The degree of similarity is set high also when the number of people calculated for one image and the number of people calculated for another image are both zero.

The first method can employ various known technologies for face detection. For example, AdaBoost (Yoav Freund, Robert E. Schapire, “A decision-theoretic generalization of on-line learning and an application to boosting,” European Conference on Computational Learning Theory, Sep. 20, 1995) may be used. In AdaBoost, a plurality of weak classifiers weighted by classifying a large number of training samples (face and non-face sample images) sequentially classifies parts of a frame of a moving image, to thereby detect a face.

Described next as the second method is a method of calculating the degree of similarity based on whether or not persons contained in images are the same person. In this method of calculating the degree of similarity, face recognition is perfoiined on each compared image to determine whether or not the same person is detected in the compared images. When the same person is detected in the compared images, the degree of similarity between the images is set high.

The second method can employ various known technologies for face recognition. For example, the face of a person which is detected in an image through face detection may be compared with a sample image of a specific person which is recorded in advance. To give another example, a person's face detected in one image and a person's face detected in another image may be compared with each other.

As the third method, a method of calculating the degree of similarity by utilizing a “feature vector” which indicates the feature amount of an image is described with reference to the drawings. The following description takes as an example a feature vector calculation method that uses the feature vector of a background region, which is a region remaining after a person region is removed from the whole image. A person region can be calculated by estimating which region contains a person based on the location and size of a face region that is detected by, for example, face detection as described above. In the case of an image that does not contain a person, the entire image can be a background region.

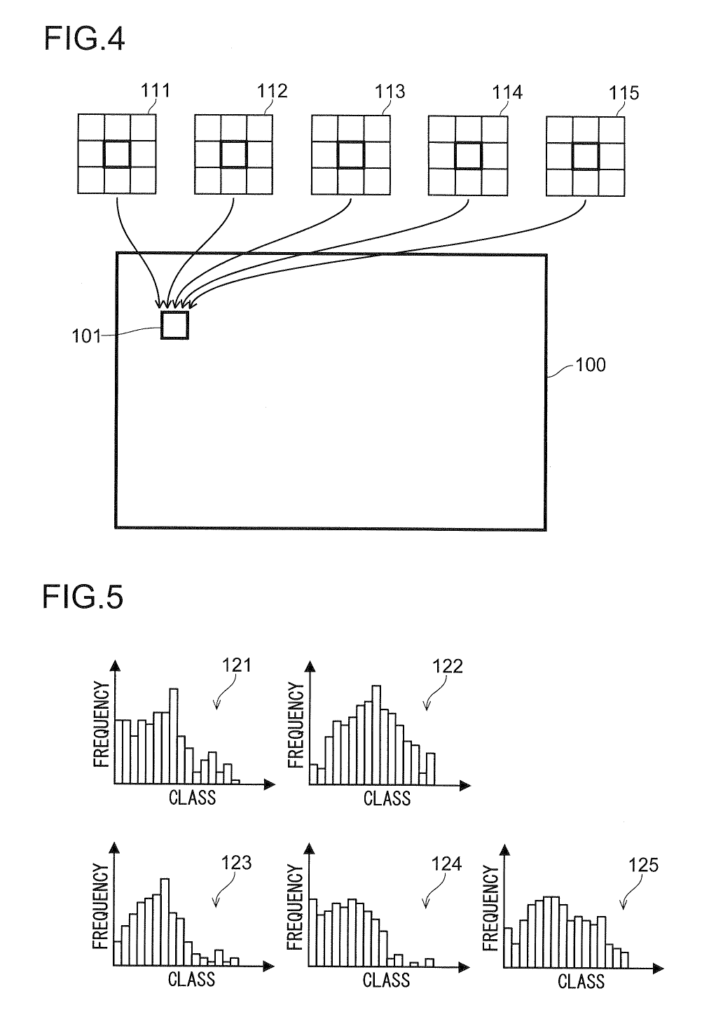

FIGS. 4 and 5 are diagrams illustrating an example of the method of calculating the feature vector. An image 100 illustrated in FIG. 4 is a two-dimensional image including a plurality of pixels arranged in horizontal and vertical directions. Filters 111 to 115 are edge extracting filters which extract edges in a small region (for example, region in image 100 having 3×3 pixels) having a focused pixel 101 as a center thereof, in the image 100. As the edge extracting filters, arbitrary spatial filters appropriate for edge extraction (for example, differential filters such as Sobel filter or Prewitt filter) may be used. Note that, the filters 111 to 115 are different from one another. Further, in FIG. 4, a filter size of the filters 111 to 115 and the small region where the filters are caused to function are assumed to be 3×3 pixels as the example, but may be other sizes such as 5×5 pixels. Further, the number of filters to be used may be a number other than five.

The filters 111, 112, 113, and 114 extract edges extending in the horizontal direction, the vertical direction, a right oblique direction, and a left oblique direction of the image 100, respectively, and output filter output values indicating intensity of the extracted edges. The filter 115 extracts an edge extending in a direction not classified in the horizontal direction, the vertical direction, the right oblique direction, and the left oblique direction, and outputs a filter output value indicating intensity of the extracted edge.

The intensity of the edge represents a gradient magnitude of a pixel signal (for example, luminance signal). For example, when there is an edge extending in the horizontal direction of the image 100, a relatively large gradient occurs in the pixel signal in the vertical direction which is orthogonal to the horizontal direction. Further, for example, when spatial filtering is performed by causing the filter 111 to function on the small region having the focused pixel 101 at the center thereof, the gradient magnitude of the pixel signal along the vertical direction of the small region having the focused pixel 101 at the center thereof is obtained as the filter output value. Note that, this is common to the filters 112 to 115.

In a state in which a certain pixel in the image 100 is determined as the focused pixel 101, the filters 111 to 115 are caused to function on the small region having the focused pixel 101 at the center thereof, to thereby obtain five filter output values. Among the five filter output values, the maximum filter output value is extracted as an adopted filter value. When the maximum filter output value is the filter output value obtained from one of the filters 111 to 115, the adopted filter value is called one of a first adopted filter value to a fifth adopted filter value. Therefore, for example, when the maximum filter output value is the filter output value from the filter 111, the adopted filter value is the first adopted filter value, and when the maximum filter output value is the filter output value from the filter 112, the adopted filter value is the second adopted filter value.

The position of the focused pixel 101 is caused to move from one pixel to another in the horizontal direction and the vertical direction in the background region of the image 100, for example. In each movement, the filter output values of the filters 111 to 115 are obtained, to thereby determine the adopted filter value. After the adopted filter values with respect to all the pixels in the background region of the image 100 are determined, histograms 121 to 125 of the first to fifth adopted filter values as illustrated in FIG. 5 are individually created.

The histogram 121 of the first adopted filter value is a histogram of the first adopted filter value obtained from the image 100. In the example illustrated in FIG. 5, the number of bins of the histogram is 16 (this is common to histograms 122 to 125). In this case, 16 frequency data items may be obtained from one histogram, and hence 80 frequency data items may be obtained from the histograms 121 to 125. An 80-dimensional vector having the 80 frequency data items as elements thereof is obtained as a shape vector H_{E}. The shape vector H_{E} is a vector corresponding to a shape of an object existing in the image 100.

In addition, color histograms representing a state of color in the background region of the image 100 are created. For example, when pixel signals in each pixel forming the image 100 include an R signal representing intensity of red color, a G signal representing intensity of green color, and a B signal representing intensity of blue color, a histogram HST_{R} of an R signal value, a histogram HST_{G} of a G signal value, and a histogram HST_{B} of a B signal value in the background region of the image 100 are created as the color histograms of the image 100. For example, when the number of bins of each color histogram is 16, 48 frequency data items may be obtained from the color histograms HST_{R}, HST_{G}, and HST_{B}. A vector (for example, 48-dimensional vector) having the frequency data items obtained from the color histograms as elements thereof is obtained as a color vector H_{C}.

When the feature vector of the image 100 is expressed by H, the feature vector H is obtained by an expression “H=k_{C}×H_{C}+k_{E}×H_{E}”, where k_{C} and k_{E} denote predetermined coefficients (note that, k_{C}≠0 and k_{E}≠0). Therefore, the feature vector H of the image 100 represents the image feature amounts in accordance with a shape and color of an object in the image 100.

A method of calculating the degree of similarity by using the feature vector H which is calculated in the manner described above is now described. To calculate the degree of similarity between two images, for example, feature vectors H₁ and H₂ of the respective images are calculated first. The feature vectors H₁ and H₂ are placed into a space where the feature vector H is to be defined. The start points of the feature vectors H₁ and H₂ are placed at the origin, and the distance (Euclidean distance) between the end point of the feature vector H₁ and the end point of the feature vector H₂ in the feature space is calculated. The calculation of the degree of similarity is then performed so that the degree of similarity is larger when this distance is shorter. The calculation of the degree of similarity may be performed such that the degree of similarity is particularly high when this distance is shorter than a reference distance, which is a given distance.

Note that, in a moving picture experts group (MPEG) 7, the derivation of the feature vector H (feature amount) of the image is performed by using five edge extracting filters. Moreover, the five edge extracting filters may be applied to the filters 111 to 115. In addition, the feature vector H (feature amount) of the image 100 may be derived by applying a method standardized in MPEG 7 to the image 100. Further, the feature vector H may be calculated by using only one of the feature amounts of a shape and color.

The degree of correlation between image data items recorded in the image recording unit 2 may be calculated in advance. Alternatively, the display control unit 5 may calculate the degree of correlation at the time corresponding images displayed on the display unit 4 are switched. Details of when to calculate the degree of correlation (when to determine whether there is a close correlation or not) are described later.

[Switching Amount]

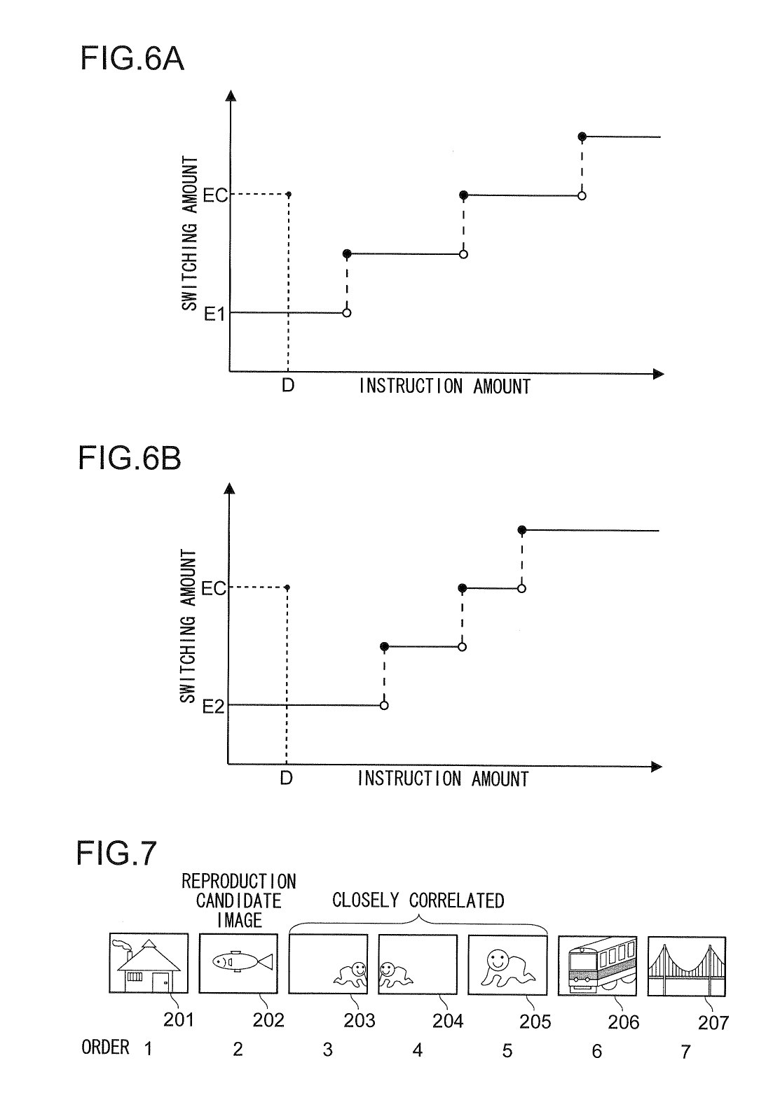

Described next with reference to the drawings is the switching amount that is set when corresponding images to be switched have a close correlation. FIGS. 6A and 6B are graphs showing examples of a relation of the instruction amount to the switching amount that is set for the switching of closely correlated corresponding images. FIGS. 6A and 6B correspond to FIGS. 3A and 3B, which show the basic relation between the instruction amount and the switching amount.

The case where corresponding images to be switched have a close correlation is, for example, a case where the correlation is close between an image data item to which the current reproduction candidate image corresponds and an image data item that precedes (when going backward) or follows (when going forward) this image data item in the order (i.e., the image data item of a corresponding image that turns into a reproduction candidate image at least next to the current reproduction candidate image). To give a concrete example, corresponding images to be switched have a close correlation when the correlation is close at least between an image data item to which the current reproduction candidate image corresponds and an image data item that is immediately before or after this image data item in the order. Corresponding images to be switched do not have a close correlation when the correlation between those image data items is not close.

To switch corresponding images that do not have a close correlation, the switching amount is set in accordance with the basic relation described above. Specifically, switching amounts E1 and E2, for example, are set with respect to an instruction amount D as shown in FIGS. 6A and 6B. To switch corresponding images that have a close correlation, on the other hand, the switching amount set is EC which does not satisfy the basic relation described above and which is determined by a method different from the one for the switching amounts E1 and E2.

The image display device 1 structured as above can vary how corresponding images are switched depending on whether the correlation between the corresponding images is close or not. Switching suited to each specific set of corresponding images is thus executed. In particular, corresponding images that have a close correlation can be switched quickly by setting a large switching amount for the switching of closely correlated corresponding images. This allows the user to easily and quickly switch corresponding images that are not wanted at the moment, with the result that desired corresponding images are displayed easily and quickly. The user can accordingly select desired image data easily and quickly.

[Display Example]

Concrete examples of how display looks when corresponding images displayed on the display unit 4 are switched (first to fourth display examples) are described next with reference to the drawings. FIG. 7 is a diagram illustrating an example of a set of corresponding images and their order. In FIG. 7, a corresponding image 201 is the first in the order, a corresponding image 202 is the second in the order, a corresponding image 203 is the third in the order, a corresponding image 204 is the fourth in the order, a corresponding image 205 is the fifth in the order, a corresponding image 206 is the sixth in the order, and a corresponding image 207 is the seventh in the order.

The corresponding image 203 and the corresponding image 204 can be determined as having a close correlation. Similarly, the corresponding image 204 and the corresponding image 205 can be determined as having a close correlation. It can therefore be determined that the corresponding images 203 to 205 have a close correlation. The determination that the corresponding images 203 to 205 have a close correlation may be made as a result of directly comparing image data items to which the corresponding images 203 to 205 respectively correspond.

In the first to fourth display examples described below, the corresponding images 201 to 207 are each checked in advance before switching (for example, at the time of image taking or transferring; details are described later) for whether or not the corresponding image has a close correlation with other corresponding images, unless otherwise stated.

{First Display Example}

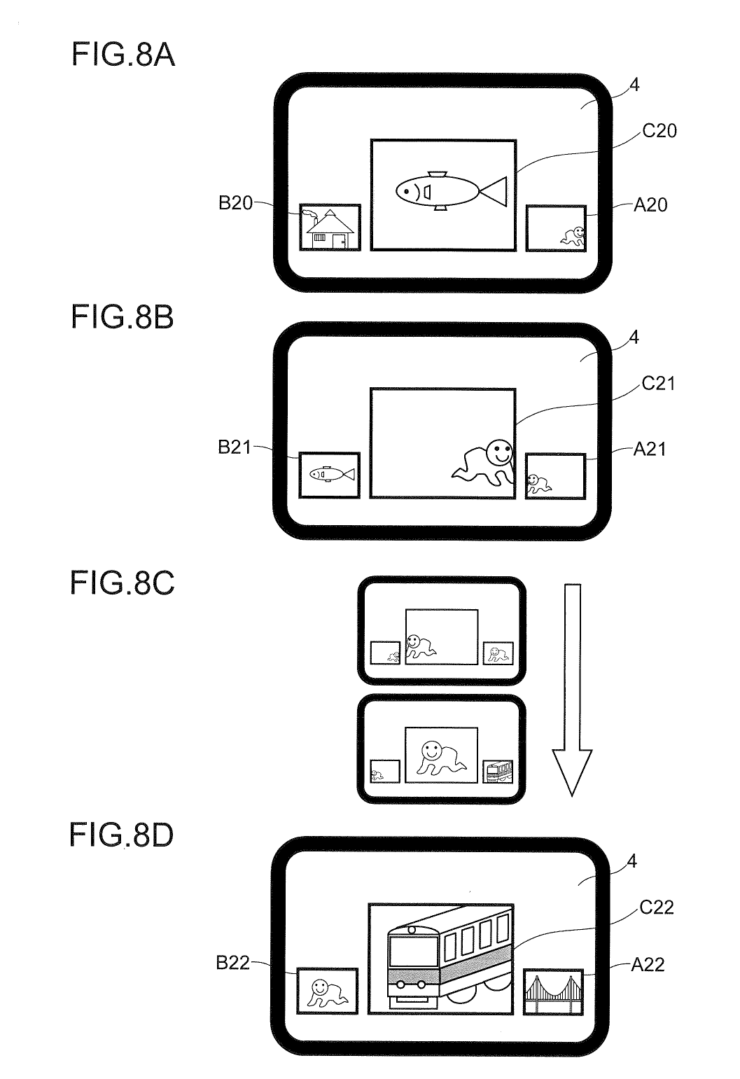

FIGS. 8A to 8D are diagrams illustrating the first display example. The example of FIGS. 8A to 8D uses the same display method as the one illustrated in FIGS. 2A to 2C to display corresponding images.

In FIG. 8A, the corresponding image 201 is a preceding candidate image B20, the corresponding image 202 is a reproduction candidate image C20, and the corresponding image 203 is a next candidate image A20. Discussed below is a case where switching instructions having the instruction amount D of FIGS. 6A and 6D are sequentially input in this state to go forward through the corresponding images in order.

The corresponding image 202 (reproduction candidate image C20) and the corresponding image 203 (next candidate image A20) do not have a close correlation as described above. Therefore, when a switching instruction having the instruction amount D is input in FIG. 8A, as many corresponding images as indicated by the switching amounts E1 and E2 (in this example, one) of FIGS. 6A and 6B are switched to go forward and reach a state of FIG. 8B, where the corresponding image 202 is a preceding candidate image B21, the corresponding image 203 is a reproduction candidate image C21, and the corresponding image 204 is a next candidate image A21.

As described above, the corresponding image 203 (reproduction candidate image C21), the corresponding image 204 (next candidate image A21), and the corresponding image 205 have a close correlation. Therefore, when a switching instruction having the instruction amount D is input in FIG. 8B, as many corresponding images as indicated by the switching amount EC of FIGS. 6A and 6B are switched. The switching amount EC in this example is large enough to switch all of the corresponding images 203 to 205 which have a close correlation (in this example, three).

This switching brings FIG. 8B to a state of FIG. 8C and then to a state of FIG. 8D, where the corresponding image 205 is a preceding candidate image B22, the corresponding image 206 is a reproduction candidate image C22, and the corresponding image 207 is a next candidate image A22. FIG. 8C is a transition state from FIG. 8B to FIG. 8D which includes a state in which the corresponding image 203 is the preceding candidate image, the corresponding image 204 is the reproduction candidate image, and the corresponding image 205 is the next candidate image, and a subsequent state in which the corresponding image 204 is the preceding candidate image, the corresponding image 205 is the reproduction candidate image, and the corresponding image 206 is the next candidate image.

When images are displayed and switched in the manner described above, it seems to the user as if the corresponding images 203 to 205 are switched at high speed.

In the case where the determination of whether there is a close correlation or not is performed at the time of switching in this example, executing the determination can be difficult, in terms of calculation amount and calculation speed, for other correlations than the correlation between the current reproduction candidate image and few corresponding images preceding (in the case of going backward) or following (in the case of going forward) the reproduction candidate image in the order. A countermeasure is, for example, to set the switching amount EC to a value based on the instruction amount D or to a given value. The switching amount EC may be set to a value based on the instruction amount D or to a given value also when whether there is a close correlation or not is determined in advance.

Setting the switching amount EC to a value based on the instruction amount D or to a given value may cause a situation where the corresponding images 203 to 205 which have a close correlation are not switched at once to go forward (in other words, one of the states of FIG. 8C is reached in one switching but no further), or a situation where the corresponding images 206 and 207 which do not have a close correlation with the reproduction candidate image C21 (corresponding image 203) are switched to go forward together with the corresponding images 203 to 205. When the latter situation occurs, there is a chance of overlooking a corresponding image that is important to a search for an image data item, which is a problem. This problematic situation can be avoided by setting the switching amount EC to a value that is within the limit of the number of corresponding images for which the determination of whether or not there is a close correlation can be performed, and that equals the number of corresponding images determined as having a close correlation and switched at once.

{Second Display Example}

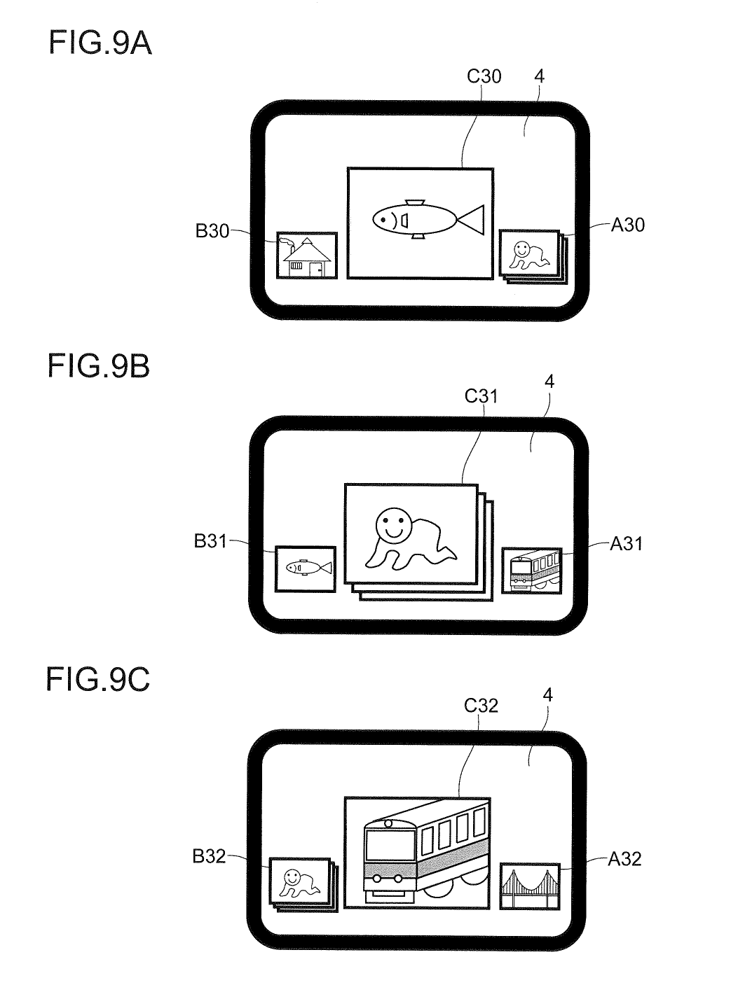

FIGS. 9A to 9C are diagrams illustrating the second display example and correspond to FIGS. 8A to 8D, which illustrate the first display example. As in FIGS. 8A to 8D, the example of FIGS. 9A to 9C also uses the same display method that is illustrated in FIGS. 2A to 2C to display corresponding images.

In FIG. 9A, the corresponding image 201 is a preceding candidate image B30 and the corresponding image 202 is a reproduction candidate image C30. A next candidate image A30 in FIG. 9A is constituted of the closely correlated corresponding images 203 to 205 which are overlaid on top of one another to be grouped together into one stack. Discussed below is a case where switching instructions having the instruction amount D of FIGS. 6A and 6D are sequentially input in this state to go forward through the corresponding images in order.

The corresponding image 202 (reproduction candidate image C30) and the corresponding images 203 to 205 (next candidate image A30) do not have a close correlation as described above. Therefore, when a switching instruction having the instruction amount D is input in FIG. 9A, as many corresponding images as indicated by the switching amounts E1 and E2 (in this example, one) of FIGS. 6A and 6B are switched to go forward and reach a state of FIG. 9B, where the corresponding image 202 is a preceding candidate image B31, a stack of corresponding images obtained by overlaying the corresponding images 203 to 205 on top of one another to be grouped together into one stack is a reproduction candidate image C31, and the corresponding image 206 is a next candidate image A31.

As described above, the corresponding images 203 to 205 (reproduction candidate image C31) have a close correlation. Therefore, when a switching instruction having the instruction amount D is input in FIG. 9B, as many corresponding images as indicated by the switching amount EC of FIGS. 6A and 6B are switched. The switching amount EC in this example is large enough to switch all of the corresponding images 203 to 205 which have a close correlation (in this example, three).

This switching brings FIG. 9B to a state of FIG. 9C, where the corresponding images 203 to 205 which are overlaid on top of one another to be grouped together into one stack are a preceding candidate image B32, the corresponding image 206 is a reproduction candidate image C32, and the corresponding image 207 is a next candidate image A32.

When images are displayed and switched in the manner described above, it seems to the user as if the corresponding images 203 to 205 are switched in a mass to go forward.

In this example, one representative corresponding image (corresponding image 205) selected out of the corresponding images 203 to 205 which are overlaid on top of one another to be grouped together into one stack is displayed in the same way as other corresponding images. The representative corresponding image can be any of the corresponding images 203 to 205 and, in this example, the corresponding image 205 which is the last of the three corresponding images in the order serves as the representative corresponding image. In the case where corresponding images are arranged in the order of image taking time or the order of image taking, for example, an image data item that is the last in the order is likely to be one with which the person who took the image is satisfied, and is not likely to be image data obtained from failed image taking. Therefore, selecting a corresponding image that is the last in the order as the representative corresponding image enables the user to grasp the entire set of corresponding images that have a close correlation when the corresponding images are thumbnail images or reduced images.

The stack of corresponding images obtained by overlaying the corresponding images 203 to 205 on top of one another may always be displayed as a stack irrespective of whether the switching of corresponding images is to be executed or not. Alternatively, the corresponding images 203 to 205 may be displayed individually instead of as a stack when the switching of images is not planned.

{Third Display Example}

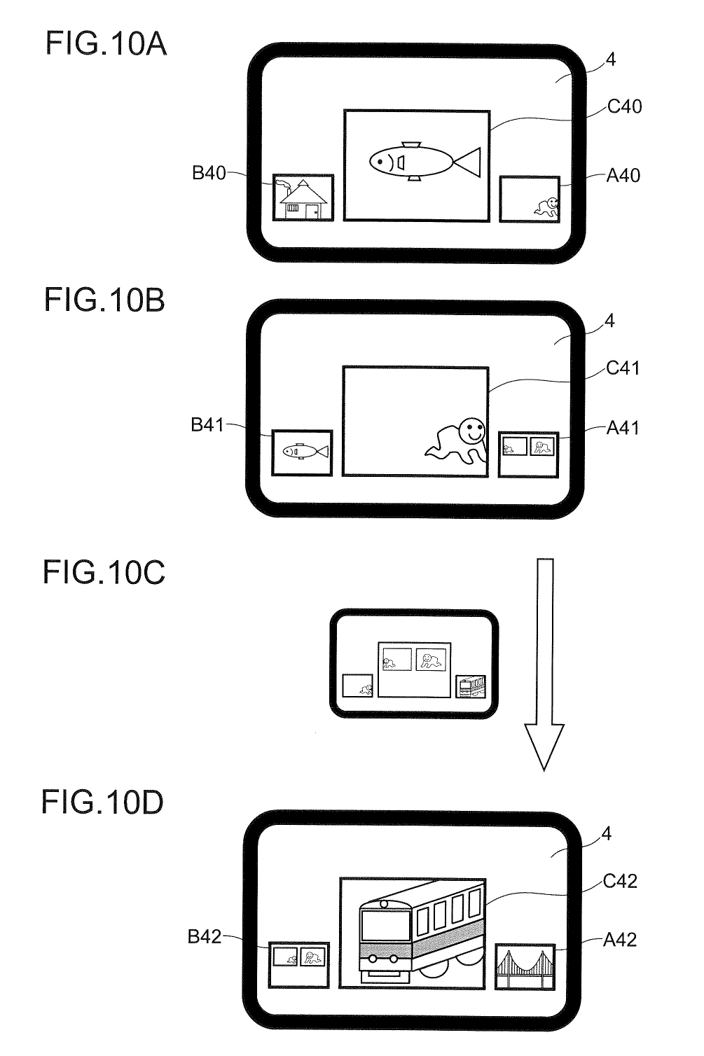

FIGS. 10A to 10D are diagrams illustrating the third display example and correspond to FIGS. 8A to 8D and FIGS. 9A to 9C, which illustrate the first display example and the second display example, respectively. As in FIGS. 8A to 8D and FIGS. 9A to 9D, the example of FIGS. 10A to 10D uses the same display method that is illustrated in FIGS. 2A to 2C to display corresponding images.

In FIG. 10A, the corresponding image 201 is a preceding candidate image B40, the corresponding image 202 is a reproduction candidate image C40, and the corresponding image 203 is a next candidate image A40. Discussed below is a case where switching instructions having the instruction amount D of FIGS. 6A and 6D are sequentially input in this state to go forward through the corresponding images in order.

The corresponding image 202 (reproduction candidate image C40) and the corresponding image 203 (next candidate image A40) do not have a close correlation as described above. Therefore, when a switching instruction having the instruction amount D is input in FIG. 10A, as many corresponding images as indicated by the switching amounts E1 and E2 (in this example, one) of FIGS. 6A and 6B are switched to go forward and reach a state of FIG. 10B, where the corresponding image 202 is a preceding candidate image B41, the corresponding image 203 is a reproduction candidate image C41, a combined corresponding image obtained by grouping together the corresponding images 204 and 205 into one group is a next candidate image A41.

As described above, the corresponding image 203 (reproduction candidate image C41), and the corresponding image 204 and the corresponding image 205 (next candidate image A41) have a close correlation. Therefore, when a switching instruction having the instruction amount D is input in FIG. 10B, as many corresponding images as indicated by the switching amount EC of FIGS. 6A and 6B are switched. The switching amount EC in this example is large enough to switch all of the corresponding images 203 to 205 which have a close correlation (in this example, three).

This switching brings FIG. 10B to a state of FIG. 10C and then to FIG. 10D, where the combined corresponding image obtained by grouping together the corresponding images 204 and 205 into one group is a preceding candidate image B42, the corresponding image 206 is a reproduction candidate image C42, and the corresponding image 207 is a next candidate image A42. FIG. 10C is a transition state from FIG. 10B to FIG. 10D which includes a state where the corresponding image 203 is the preceding candidate image, the combined corresponding image obtained by grouping together the corresponding images 204 and 205 into one group is the reproduction candidate image, and the corresponding image 206 is the next candidate image.

When images are displayed and switched in the manner described above, it seems to the user as if the corresponding images 203 to 205 are switched in a mass to go forward.

In this display example, the first corresponding image 230 in order among the corresponding images 203 to 205, which have a close correlation to one another, is displayed independently without being grouped together. The corresponding images 204 and 205 are displayed as a combined image obtained by grouping the corresponding images 204 and 205 into one group. Displaying independently the corresponding image 230 which is the first in the order enables the user to easily grasp that the corresponding images grouped together relate with the preceding corresponding image 203.

The combined corresponding image obtained by grouping the corresponding images 204 and 205 into one group may always be displayed as a group irrespective of whether the switching of corresponding images is to be executed or not. Alternatively, the corresponding images 204 and 205 may be displayed individually instead of as a group when the switching of images is not planned.

The corresponding images that are combined into one corresponding image may be the corresponding images 203 to 205 as in the second display example described above, or it may be the corresponding images 204 and 205 that are overlaid on each other to be one corresponding image. The corresponding image that is displayed independently instead of as part of a combined image may be the corresponding image 205, while the corresponding images 203 and 204 are combined into one corresponding image.

{Fourth Display Example}

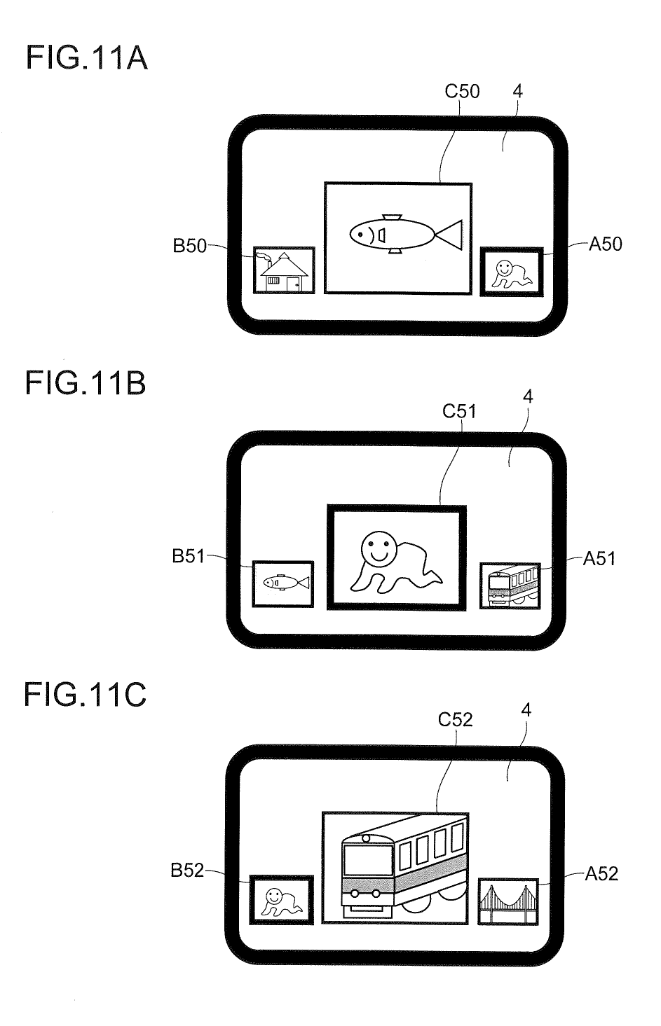

FIGS. 11A to 11C are diagrams illustrating the fourth display example and correspond to FIGS. 8A to 8D, FIGS. 9A to 9C, and FIGS. 10A to 10D, which illustrate the first to third display examples, respectively. As in FIGS. 8A to 8D, FIGS. 9A to 9C, and FIGS. 10A to 10D, the example of FIGS. 11A to 11C uses the same display method that is illustrated in FIGS. 2A to 2C to display corresponding images.

In FIG. 11A, the corresponding image 201 is a preceding candidate image B50 and the corresponding image 202 is a reproduction candidate image C50. A next candidate image A50 in FIG. 11A is a grouped corresponding image obtained by displaying only one of the corresponding images 203 to 205 which have a close correlation (by omitting the display of the other two of the corresponding images 203 to 205). Discussed below is a case where switching instructions having the instruction amount D of FIGS. 6A and 6D are sequentially input in this state to go forward through the corresponding images in order.

The corresponding image 202 (reproduction candidate image C50) and the corresponding images 203 to 205 (next candidate image A50) do not have a close correlation as described above. Therefore, when a switching instruction having the instruction amount D is input in FIG. 11A, as many corresponding images as indicated by the switching amounts E1 and E2 (in this example, one) of FIGS. 6A and 6B are switched to go forward and reach a state of FIG. 11B, where the corresponding image 202 is a preceding candidate image B51, a grouped corresponding image obtained by displaying only one of the corresponding images 203 to 205 is a reproduction candidate image C51, and the corresponding image 206 is a next candidate image A51.

As described above, the corresponding images 203 to 205 (reproduction candidate image C31) have a close correlation. Therefore, when a switching instruction having the instruction amount D is input in FIG. 11B, as many corresponding images as indicated by the switching amount EC of FIGS. 6A and 6B are switched. The switching amount EC in this example is large enough to switch all of the corresponding images 203 to 205 which have a close correlation (in this example, three).

This switching brings FIG. 11B to a state of FIG. 11C, where a grouped corresponding image obtained by displaying only one of the corresponding images 203 to 205 is a preceding candidate image B52, the corresponding image 206 is a reproduction candidate image C52, and the corresponding image 207 is a next candidate image A52.

When images are displayed and switched in the manner described above, it seems to the user as if the corresponding images 203 to 205 are switched in a mass to go forward.

In this example, the grouped corresponding image obtained by displaying only one of the corresponding images 203 to 205, namely, one representative corresponding image to be displayed, is the corresponding image 205. The representative corresponding image can be any of the corresponding images 203 to 205. However, as described in the second display example, selecting a corresponding image that is the last in the order as the representative corresponding image enables the user to grasp the entire set of corresponding images that have a close correlation.

The grouped corresponding image of this display example which is obtained by displaying only one of the corresponding images 203 to 205 is difficult to distinguish from other corresponding images if displayed as it is. The grouped corresponding image therefore is preferred to announce itself as a grouped corresponding image in some way. An image can be announced as a grouped corresponding image by, for example, displaying the image in a frame wider than that of other corresponding images as illustrated in FIGS. 11A to 11C, or by displaying the image in a frame different in color or design from that of other corresponding images, or by displaying the image together with an icon or the like.

The grouped corresponding image obtained by displaying only one of the corresponding images 203 to 205 may always be displayed as a group irrespective of whether the switching of corresponding images is to be executed or not. Alternatively, the corresponding images 203 to 205 may be displayed individually instead of as a group when the switching of images is not planned.

The announcement of a grouped corresponding image described above is not limited to the fourth display example and may be employed in the first to third display examples, where the grouped corresponding image displays the closely correlated corresponding images 203 to 205 directly (first display example) or indirectly (second and third display examples).

<Modification Example of Switching Control>

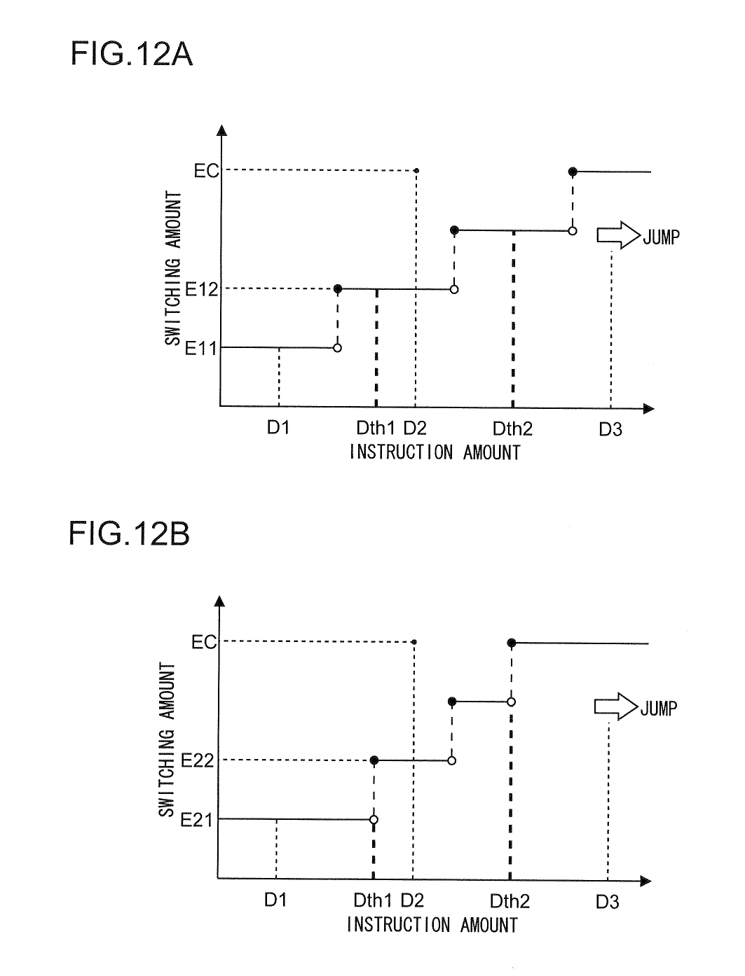

A description is given below with reference to the drawings on a modification example of switching control that is executed when corresponding images having a close correlation are switched. FIGS. 12A and 12B are graphs showing examples of a relation between the instruction amount and the switching amount to show a modification example of the switching control. FIGS. 12A and 12B correspond to FIGS. 3A and 3B, which show the basic relation between the instruction amount and the switching amount, and FIGS. 6A and 6B, which show examples of switching control.

As shown in FIGS. 12A and 12B, upon input of an instruction amount D1 which is equal to or smaller than a threshold Dth1, switching amounts E11 and E21 which satisfy the basic relation are set in this modification example irrespective of whether corresponding images to be switched have a close correlation or not (in other words, the switching amount EC equals the switching amounts E11 and E21).

When the input instruction amount is an instruction amount D2 which is larger than the threshold Dth1 and smaller than a threshold Dth2, the same switching control as in the examples of FIGS. 6A and 6B is executed. Specifically, switching amounts E12 and E22 are set in accordance with the basic relation when corresponding images to be switched do not have a close correlation and, when corresponding images to be switched have a close correlation, the switching amount EC that is equal to or larger than the switching amounts E12 and E22 is set instead of adhering to the basic relation.

In this modification example, the screen jumps to an image in the next category when an instruction amount D3 which is equal to or larger than the threshold Dth2 is input. A “category” is, for example, a group of image data items that have the same image taking date, the same image taking location, the same event where image taking took place, or the like. A “jump” is a switch to a corresponding image that belongs to the next category (for example, a corresponding image that is the first in the order within the category). A jump is executed by, for example, setting a switching amount (y−x+1), which is based on the order (x) of the current reproduction candidate image in a category and the number (y) of corresponding images belonging to this category.

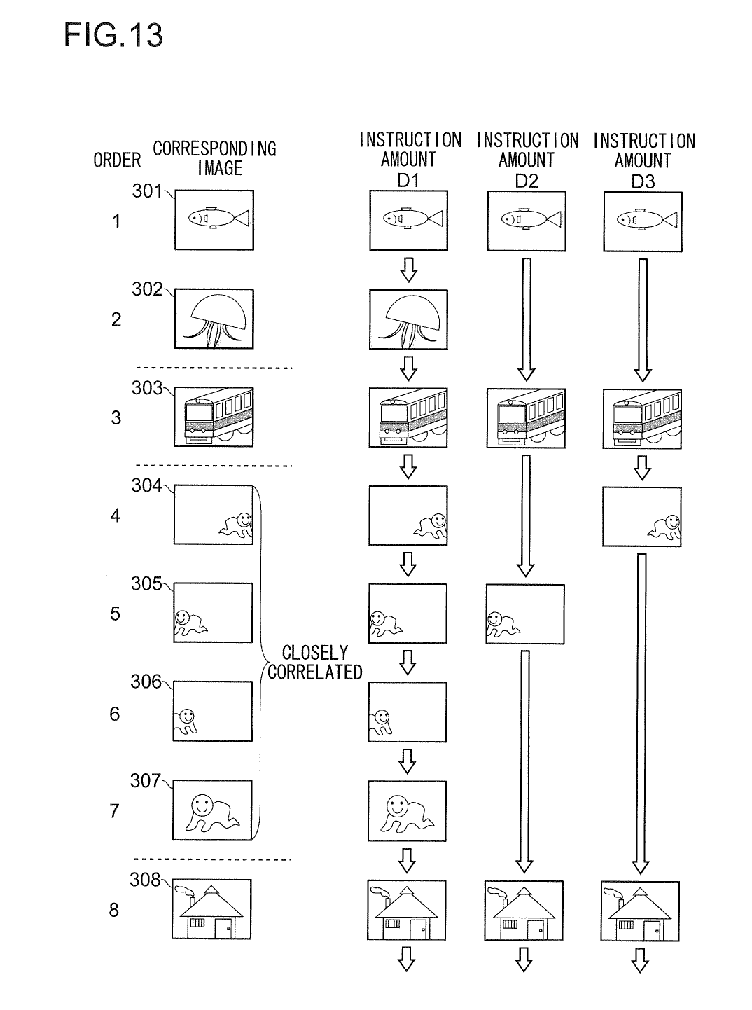

A description is given below with reference to the drawing on a concrete example of how corresponding images are switched when the instruction amounts D1 to D3 of FIGS. 12A and 12B are each input continuously to the display control unit 5. FIG. 13 is a diagram showing an example of how corresponding images are switched when various instruction amounts are input.

In FIG. 13, a corresponding image 301 is the first in the order, a corresponding image 302 is the second in the order, a corresponding image 303 is the third in the order, a corresponding image 304 is the fourth in the order, a corresponding image 305 is the fifth in the order, a corresponding image 306 is the sixth in the order, a corresponding image 307 is the seventh in the order, and a corresponding image 308 is the eighth in the order. The corresponding images 304 and 305 can be determined as having a close correlation, as are the corresponding images 305 and 306 and the corresponding images 306 and 307. It can therefore be determined that the corresponding images 304 to 307 have a close correlation. The determination that the corresponding images 304 to 307 have a close correlation may be made as a result of directly comparing image data items to which the corresponding images 304 to 307 respectively correspond.

The corresponding images 301 and 302 belong to the same category. The corresponding image 303 belongs to a category of its own. The corresponding images 304 to 307 belong to the same category. The corresponding image 308 belongs to a category of its own. In FIG. 13, one category is separated from another by a broken line.

FIG. 13 illustrates switching in which corresponding images are switched in order with the corresponding image 301 as the start point. Unlike FIGS. 8A to 8D, FIGS. 9A to 9C, FIGS. 10A to 10D, and FIGS. 11A to 11C, FIG. 13 focuses on switching (going forward by) one corresponding image (for example, the reproduction candidate image) in order to simplify the illustration.

When the input instruction amount is D1, the switching amounts E11 and E21 which satisfy the basic relation are set. In the example of FIG. 13, corresponding images are switched one by one to go forward (E11=E21=1). The corresponding images 301 to 308 are therefore switched to go forward in order one at a time whenever the instruction amount D1 is input (whenever the user operates the operation unit 3).

In this example, although the corresponding image 304 and the corresponding image 305 which follows the corresponding image 304 in the order have a close correlation, the switching amounts E11 and E21 which satisfy the basic relation are set as described above. The corresponding images 304 and 305 are accordingly switched to go forward one at a time (the same is true when the corresponding images 306 and 307 are switched to go forward).

When the instruction amount D2 is input to switch the corresponding image 301 to go forward, the switching amounts E12 and E22 which satisfy the basic relation are set because the corresponding image 301 and the corresponding image 302 which follows the corresponding image 301 in the order do not have a close correlation (the same is true when the corresponding image 303 is switched to go forward). In the example of FIG. 13, two corresponding images are switched to go forward at a time (E12=E22=2).

When the instruction amount D2 is input to switch the corresponding image 305 to go forward, the switching amount EC which does not satisfy the basic relation is set because the corresponding image 305 and the corresponding images 306 and 307 which follow the corresponding image 305 in the order have a close correlation. As in the first to fourth display examples, the switching amount EC in the example of FIG. 13 is set large enough to switch all of the closely correlated corresponding images 305 to 307 to go forward (in this example, three).

When the input instruction amount is D3, corresponding images are switched to go forward on a category basis. Each time the instruction amount D3 is input (each time the user operates the operation unit 3), corresponding images are switched to go forward and reach one that is the first in the order among corresponding images belonging to the next category. Specifically, in the example of FIG. 13, the corresponding image 301 is switched first to go forward, followed by the switching of the corresponding image 303, and then 304, and then 308.

As described above, when the input instruction amount is D1 which is equal to or smaller than the threshold Dth1, the closely correlated corresponding images 304 to 307 can be switched separately (for example, in a manner that turns each into the reproduction candidate image separately) by setting the switching amounts E11 and E21, which satisfy the basic relation, irrespective of whether corresponding images to be switched have a close correlation or not. Therefore, in the case where an image data item to be selected is among image data items to which the corresponding images 304 to 307 correspond, the image data item of interest is easily selected by simply reducing the instruction amount (for example, by reducing the amount of the user's operation of the operation unit 3 at a time (or per unit time), or by shortening the length of operation at a time).

When the input instruction amount is D3 which is equal to or larger than the threshold Dth2 and corresponding images are switched on a category basis, one of the advantages is that candidates can be narrowed down at an early stage of a search for an image data item to be selected. The image data item is therefore selected easily and quickly.

The threshold Dth2 may not be provided. In this case, when the input instruction amount is larger than the threshold Dth1 and corresponding images to be switched do not have a close correlation, a switching amount that satisfies the basic relation may be set whereas the switching amount EC which does not satisfy the basic relation is set when the correlation is close.

The thresholds Dth1 and Dth2 can take any values. The thresholds Dth1 and Dth2 may be values that are different from the values at steps of the stepped basic relation as in FIG. 12A, or may be values that match the values at steps of the stepped basic relation as in FIG. 12B.

This modification example is applicable to the second to fourth display examples. In this case, a grouped corresponding image may be broken into its constituent corresponding images to be displayed and switched separately at least when, for example, the input instruction amount is equal to or smaller than the threshold Dth1.

<When to Calculate the Presence or Absence of Correlation>

When to execute the determination of whether corresponding images have a close correlation or not is described next with reference to the drawings.

[At the Time of Switching]

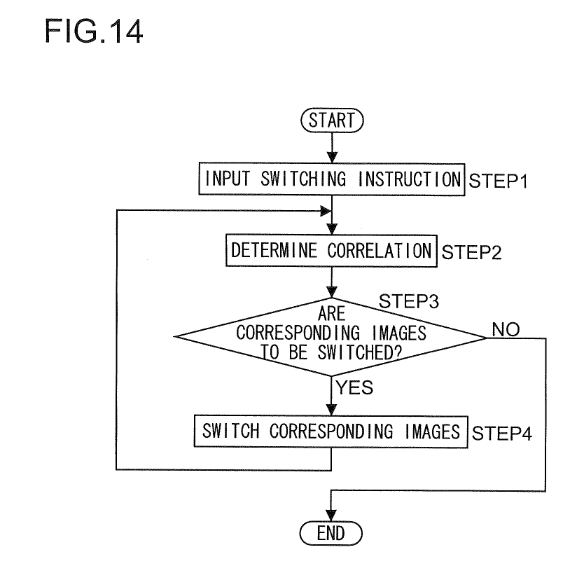

FIG. 14 is a flow chart illustrating an action of the image display device 1 in which whether the correlation between corresponding images is close or not is determined at the time of switching the corresponding images and then the corresponding images are switched. The action of FIG. 14 is executed when, for example, image data is to be reproduced on the image display device 1, and executed when the user operates the operation unit 3 once.

As illustrated in FIG. 14, a switching instruction is first input to the image display device 1 by the user operating the operation unit 3 (STEP 1). The display control unit 5 checks the instruction amount described above at this point. The display control unit 5 also determines whether or not the correlation is close between a pre-switching corresponding image (for example, the reproduction candidate image in STEP 1 or the reproduction candidate image in STEP 2) and a switching candidate corresponding image which precedes or follows this corresponding image in the order (for example, the preceding candidate image or the next candidate image in STEP 2) (STEP 2).

Based on the instruction amount and the result of the determination in STEP 2, the display control unit 5 determines whether to switch the pre-switching corresponding image to the switching candidate corresponding image (STEP 3). This determination of whether to execute a switch can be made based on whether or not the switch to the switching candidate corresponding image is within the range of the switching amount described above. Specifically, when the switching of corresponding images is within the range of the switching amount, it is determined that the corresponding images are to be switched.

As described above, the number of corresponding images, for which whether or not there is a close correlation can be determined, is limited in some cases due to the calculation amount and the calculation speed. In such cases, in STEP 3, a switching amount is set based on whether or not the determination of whether there is a close correlation or not can be executed (whether or not STEP 2 can be executed further), and whether to execute the switch is determined.

When it is determined that the corresponding images are not to be switched (STEP 3: NO), switching is ended. When it is determined that the corresponding images are to be switched (STEP 3: YES), on the other hand, the pre-switching corresponding image is switched to the switching candidate corresponding image (STEP 4). The corresponding images are switched at high speed as in the first display example. After the corresponding images are switched in STEP 4, the processing returns to STEP 2 to subsequently repeat STEP 3 and STEP 4.

The switching control described above can thus be performed on corresponding images of any kind (for example, image data items taken by a plurality of imaging devices and image data items whose information such as their order have been changed) by executing the determination of whether corresponding images (image data items) have a close correlation or not at the time of switching.

[At the Time of Transfer]

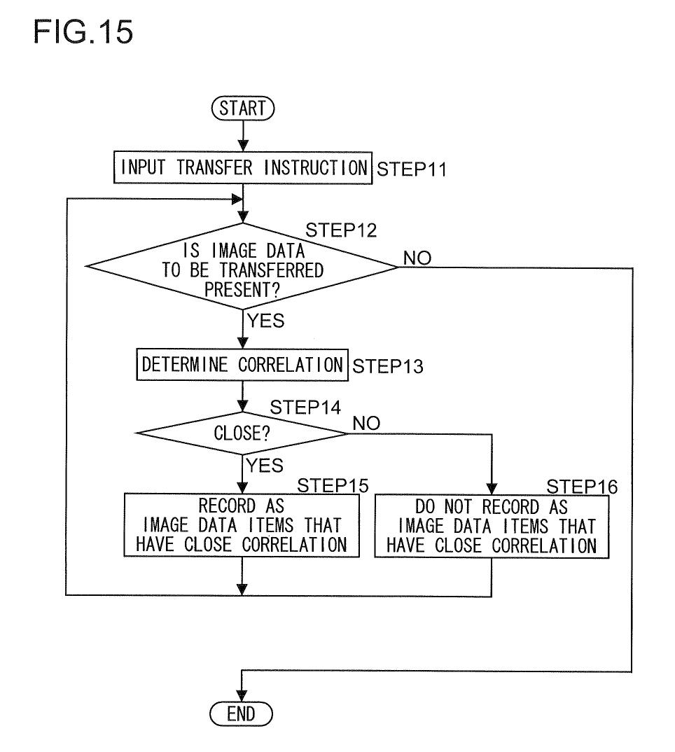

FIG. 15 is a flow chart illustrating an action of the image display device 1 in which whether there is a close correlation or not is determined at the time image data is transferred. The action of FIG. 15 is executed when, for example, image data obtained by image taking is transferred from the imaging device to a viewer (the image display device 1) or a recording device.

As illustrated in FIG. 15, a transfer instruction specifying which image data item is to be transferred is input first (STEP 11). The presence or absence of the image data item to be transferred is then checked (STEP 12). When the image data item to be transferred is not found (STEP 12: NO), the transfer is ended. When the image data item to be transferred is found (STEP 12: YES), whether or not the image data item to be transferred has a close correlation with an image data item that precedes or follows the image data item to be transferred in the order is determined (STEP 13).

When the correlation between the image data item to be transferred and its preceding or following image data item is close (STEP 14: YES), the image data items are recorded as ones that have a close correlation in the image display device or the recording device (STEP 15). At this point, information indicating that the correlation is close may be recorded in a part of each image data item such as a header, or may be recorded in a system recording area of the image display device or the recording device.

When the correlation between the image data item to be transferred and its preceding or following image data item is not close (STEP 14: NO), the image data items are recorded as ones that do not have a close correlation in the image display device or the recording device (STEP 16). At this point, as in STEP 15, information indicating that the correlation is not close may be recorded in the header or in the system recording area. Alternatively, the distant correlation may be indicated by not recording information about the correlation.

After STEP 15 or STEP 16 is finished, the processing returns to STEP 12 to check whether or not another image data item is to be transferred, and the subsequent steps are repeated.

With this structure, whether the correlation between image data items is close or not is determined prior to image data reproduction in the image display device 1. Accordingly, there is no need to execute the determination of whether or not there is a close correlation at the time of switching, and the switching control described above is completed quickly.

In STEP 15 and STEP 16, in which information indicating that the correlation is close is recorded, the degree of correlation may be recorded instead. The determination of whether there is a close correlation or not may be executed by the imaging device, or by the image display device or the recording device.

[At the Time of Image Taking]

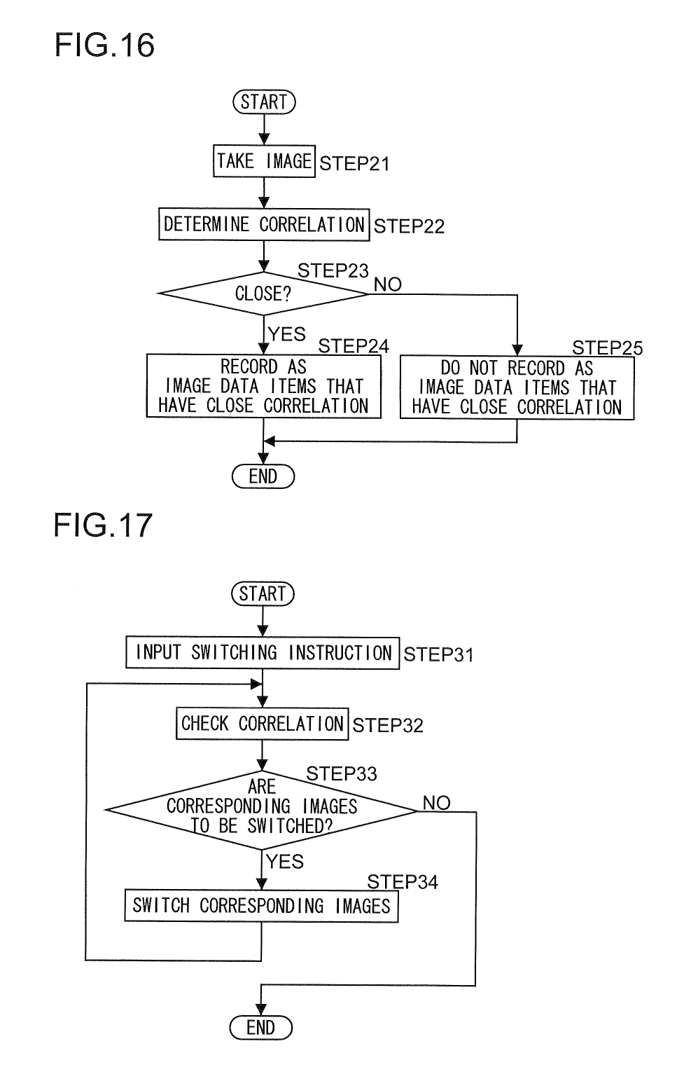

FIG. 16 is a flow chart illustrating an action of the image display device 1 in which whether image data that has just been taken has a close correlation or not is determined. The action of FIG. 16 is executed when one image data item is obtained by image taking.

As illustrated in FIG. 16, an image is taken first to obtain an image data item (STEP 21). The next step is to determine whether or not the image data item obtained by the image taking in STEP 21 has a close correlation with an image data item that precedes the obtained image data item in the order (STEP 22). When there is an image data item that follows the obtained image data item in the order, STEP 22 may include determining whether or not the obtained image data item has a close correlation with its following image data item.

When the correlation is close between the image data item obtained by image taking and the image data item that precedes (or follows) the obtained image data item in the order (STEP 23: YES), the image data items are recorded as ones that have a close correlation in a recording unit of the imaging device (STEP 24). At this point, information indicating that the correlation is close may be recorded in a part of each image data item such as a header, or may be recorded in a system recording area of the imaging device.

When the correlation is not close between the image data item obtained by image taking and the image data item that precedes (or follows) the obtained image data item in the order (STEP 23: NO), the image data items are recorded as ones that do not have a close correlation in the recording unit of the imaging device (STEP 25). At this point, as in STEP 24, information indicating that the correlation is not close may be recorded in the header or in the system recording area. Alternatively, the distant correlation may be indicated by not recording information about the correlation. After STEP 24 or STEP 25 is finished, the action is ended.

With this structure, as in the case where the determination is made at the time of transfer in the manner described above, whether the correlation between image data items is close or not is determined prior to image data reproduction in the image display device 1. Accordingly, there is no need to execute the determination of whether or not there is a close correlation at the time of switching, and the switching control described above is completed quickly.

In STEP 24 and STEP 25, where information indicating that the correlation is close is recorded, the degree of correlation may be recorded instead.

[Switching of Corresponding Images for Which Whether the Correlation is Close or Not is Determined in Advance]

Described next with reference to FIG. 17 is an action of switching corresponding images for which whether the correlation is close or not is determined in advance and recorded at the time of transfer or at the time of image taking (see the sections [At the Time of Transfer] and [At the Time of Image Taking]). FIG. 17 is a flow chart illustrating a corresponding image switching action that is executed when whether the correlation between corresponding images is close or not is determined in advance. The action of FIG. 17 is executed when, for example, image data is to be reproduced in the image display device 1, and executed each time the user operates the operation unit 3.

As illustrated in FIG. 17, a switching instruction is first input to the image display device 1 by the user operating the operation unit 3 (STEP 31). The display control unit 5 checks the instruction amount described above at this point. The display control unit 5 also checks whether or not the correlation is close between a pre-switching corresponding image (for example, the reproduction candidate image in STEP 31 or the reproduction candidate image in STEP 32) and a switching candidate corresponding image which precedes or follows this corresponding image in the order (for example, the preceding candidate image or the next candidate image in STEP 32) (STEP 32).

Based on the instruction amount and the correlation checked in STEP 32, the display control unit 5 determines whether to switch the pre-switching corresponding image to the switching candidate corresponding image (STEP 33). This determination of whether to execute a switch can be made based on whether or not the switching of the switching candidate corresponding image is within the range of the switching amount described above. Specifically, when the switch to the switching candidate corresponding image is within the range of the switching amount, it is determined that the corresponding images are to be switched.

When it is determined that the corresponding images are not to be switched (STEP 33: NO), switching is ended. When it is determined that the corresponding images are to be switched (STEP 33: YES), on the other hand, the pre-switching corresponding image is switched to the switching candidate corresponding image (STEP 34). The corresponding image is switched at high speed as in the first display example, or switched together with other corresponding images as in the second to fourth display examples. After the corresponding images are switched in STEP 34, the processing returns to STEP 32 to subsequently repeat STEP 33 and STEP 34.

As described above, when whether a corresponding image has a close correlation or not is determined in advance, the image display device 1 only needs to check the correlation at the time of switching. This allows the image display device 1 to speed up switching control and to have a simpler structure.

<Examples of an Action Executed When the User Selects a Composite Corresponding Image>

In the description given above, image data reproduced is one to which a corresponding image selected by the user (by inputting a selection instruction via the operation unit 3) corresponds. However, the user may select one corresponding image in which at least two corresponding images are grouped together (see the second to fourth display examples, FIG. 7, FIGS. 9A to 9C, FIGS. 10A to 10D, and FIGS. 11A to 11C. Hereinafter, this type of corresponding image is referred to as composite corresponding image and discriminated from a single corresponding image.). The image display device 1 is preferably structured to take a different action in this case from the case where the user selects a single corresponding image.

Examples of an action executed when the image selected by the user is a composite corresponding image are described below. The following action examples, whether they be of the same kind or of different kinds, can be combined unless there is a contradiction. What follows are mainly examples of applying the action examples to the second display example (see FIGS. 9A to 9C) and the third display example (see FIGS. 10A to 10D), and a description on the application of the action examples to the fourth display example (see FIGS. 11A to 11C) is omitted because it is similar to the application of the action examples to the second display example. In the following description of the action examples, elements in the drawings that are similar to ones in FIG. 7, FIGS. 9A to 9C, and FIGS. 10A to 10D are denoted by the same reference symbols in order to simplify the description by omitting a detailed description on those elements.

[Composite Corresponding Image Selection Detection Action]

Examples of an action executed by the display control unit 5 to detect that the user has selected a composite corresponding image are described first with reference to the drawings.

{Composite Corresponding Image Selection Detection Action: First Example}

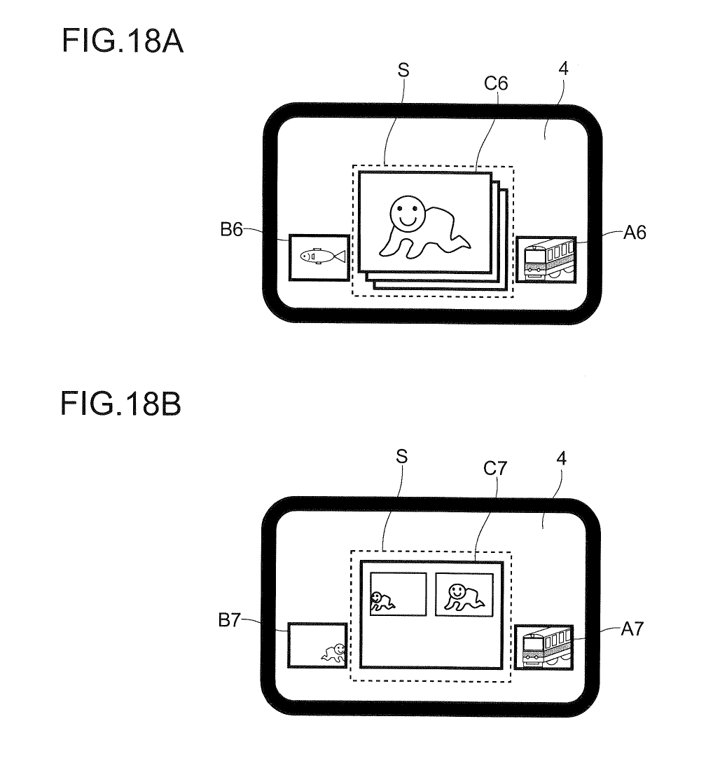

FIGS. 18A and 18B are diagrams illustrating a first example of a composite corresponding image selection detection action. FIG. 18A corresponds to the second display example, and FIG. 18B corresponds to the third display example. As illustrated in FIGS. 18A and 18B, in this action example, the display control unit 5 detects that a composite corresponding image has been selected when a composite corresponding image is situated in a selection detection range S and an instruction from the user has not been input via the operation unit 3 for a given period of time or longer. Specifically, the display control unit 5 detects that a composite corresponding image has been selected when, for example, a composite corresponding image is a reproduction candidate image C6 or C7 and an instruction from the user has not been input for a given period of time or longer.

The selection detection range S is not limited to the area where the reproduction candidate image is displayed, and may be set to the area where the preceding candidate image or the next candidate image is displayed. The selection detection range S may also be set to not one but a plurality of areas. For instance, the selection detection range S may be set to each of, or two of, the areas where the preceding candidate image, the reproduction candidate image, and the next candidate image are respectively displayed.

The state in this action example where a composite corresponding image is situated in the selection detection range S and an instruction from the user has not been input via the operation unit 3 for a given period of time or longer is similar to and interchangeable with a state in a fourth example of a post-composite corresponding image selection action which is described later.

{Composite Corresponding Image Selection Detection Action: Second Example]

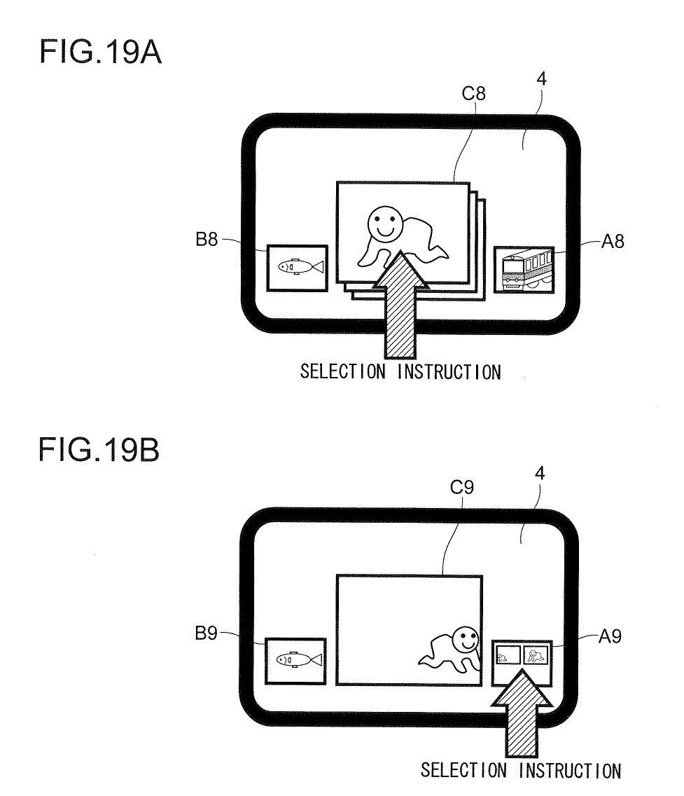

FIGS. 19A and 19B are diagrams illustrating a second example of the composite corresponding image selection detection action. FIG. 19A corresponds to the second display example, and FIG. 19B corresponds to the third display example. As illustrated in FIGS. 19A and 19B, in this action example, the display control unit 5 detects that a composite corresponding image has been selected when a selection instruction for selecting a composite corresponding image is input from the user via the operation unit 3. Specifically, the display control unit 5 detects that a composite corresponding image has been selected upon input of a selection instruction for selecting a composite corresponding image, for example, a reproduction candidate image C8 of FIG. 19A or a next candidate image A9 of FIG. 19B.

{Composite Corresponding Image Selection Detection Action: Third Example}

In this action example, the display control unit 5 detects that a composite corresponding image has been selected when a composite corresponding image is situated in the selection detection range S described in the first example of the composite corresponding image selection detection action (see FIGS. 18A and 18B) and an instruction that is not a switching instruction is input from the user via the operation unit 3.

Specifically, the display control unit 5 detects that a composite corresponding image has been selected when, for example, a composite corresponding image is the reproduction candidate image C6 and the user operates the operation unit 3 in a direction different from one for inputting a switching instruction (hereinafter referred to as switching instruction direction) (e.g., a direction perpendicular to the switching instruction direction or a direction between this direction and the switching instruction direction, which is hereinafter referred to as non-switching instruction direction.).

For example, in the case where the operation unit 3 is a touch panel and a switching instruction is input when the user slides a finger, a stylus, or the like on the touch panel (strokes the touch panel) in a direction in which a preceding candidate image B6 (B7), the reproduction candidate image C6 (C7), and a next candidate image A6 (A7) are aligned on the display unit 4 (the left-right direction in the drawings, i.e., the switching instruction direction), the user operates the operation unit 3 in a non-switching instruction direction by sliding a finger, a stylus, or the like on the display unit 4 (strokes the touch panel) along a direction that is not the switching instruction direction (the top-bottom direction or oblique direction in the drawings, i.e., a non-switching instruction direction). To give another example, in the case where the operation unit 3 is a tracking ball or a set of keys and a switching instruction is input by rolling the tracking ball in the alignment direction (switching instruction direction) or by pressing a key that is allocated to the switching instruction direction, the user operates the operation unit 3 in a non-switching instruction direction by rolling the tracking ball along a direction that is not the switching instruction direction (non-switching instruction direction) or by pressing a key that is allocated to a non-switching instruction direction.

An instruction that is not a switching instruction in this action example is similar to and interchangeable with an instruction in a third example of the post-composite corresponding image selection action which is described later.

The first to third examples of the composite corresponding image selection detection action are applicable not only to cases where a composite corresponding image is selected but also to cases where a corresponding image is selected.

[Post-composite Corresponding Image Selection Action]

Examples of an action executed by the display control unit 5 after the user selects a composite corresponding image are described next with reference to the drawings.

{Post-composite Corresponding Image Selection Action: First Example}

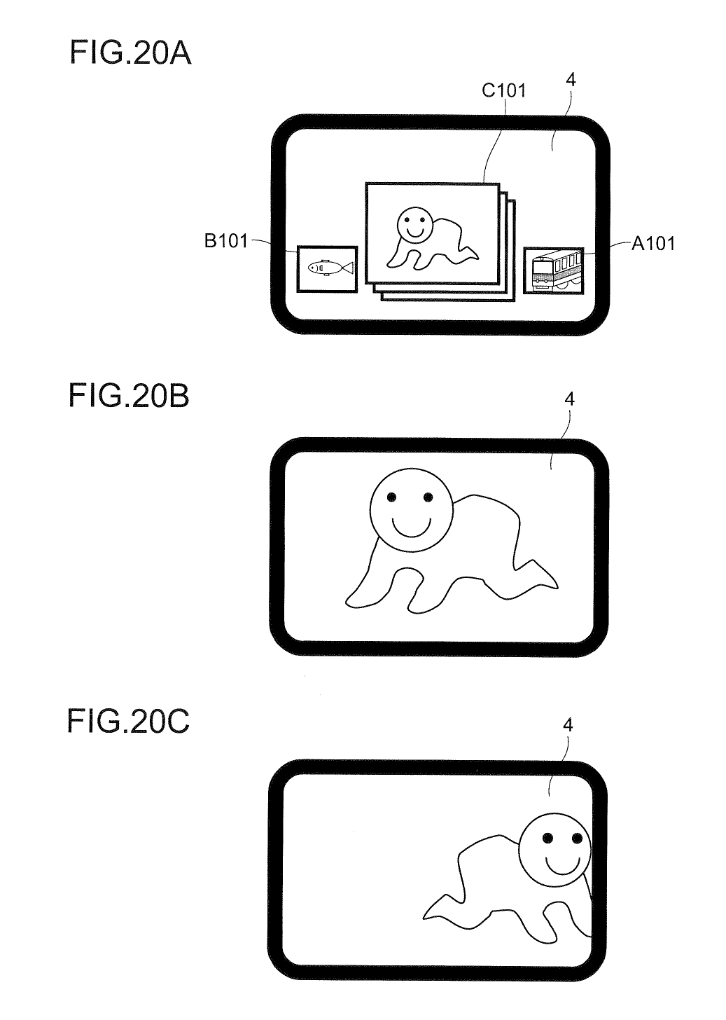

FIGS. 20A to 20C are diagrams illustrating a first example of a post-composite corresponding image selection action, and correspond to the second display example. FIG. 20A is an example of how display by the display unit 4 looks prior to the composite corresponding image selection detection action. FIG. 20B is an example of how display by the display unit 4 looks immediately after the composite corresponding image selection detection action. FIG. 20C is an example of how display by the display unit 4 looks after the user inputs an instruction that is not a switching instruction via the operation unit 3 while the display unit 4 is as shown in FIG. 20B.

As illustrated in FIGS. 20A and 20B, in this action example, the composite corresponding image selection detection action described above executed in the display control unit 5 is followed by the reproduction on the display unit 4 of image data to which one of the corresponding images constituting the selected composite corresponding image corresponds. The image data reproduced may be, for example, one associated with the representative corresponding image 205 (see FIG. 7), which is a constituent of the composite corresponding image.

While image data is being reproduced as illustrated in FIG. 20B, the user inputs an instruction that is not a switching instruction via the operation unit 3, thereby causing the display control unit 5 to reproduce on the display unit 4 image data that is not the currently reproduced image data and that is associated with one of the corresponding images constituting the selected composite corresponding image. In the example of FIG. 20C, image data to which the corresponding image 203 (see FIG. 7) corresponds is reproduced on the display unit 4.

Subsequently, the user further inputs an instruction that is not a switching instruction (for example, the user operates the operation unit 3 in a non-switching instruction direction), causing the display control unit 5 to sequentially switch the image data reproduced on the display unit 4. The image data reproduced is switched, for example, in the order of the degree of correlation, the order of the degree of similarity between images, the order of image taking date/time, or other orders described above.

This structure enables the user to easily reproduce and check image data items to which a plurality of closely correlated corresponding images respectively correspond.

In the case where the user's operation of the operation unit 3 in a non-switching instruction direction causes the switching of the image data reproduced on the display unit 4, image data may be switched in a given order which is determined depending on the direction of the operation (for example, whether the operation direction is the upward direction or the downward direction, or whether the operation direction is the oblique upward direction or the oblique downward direction). To give a concrete example, the image data reproduced on the display unit 4 may be switched in ascending order when the user operates the operation unit 3 in the upward direction, whereas the image data reproduced on the display unit 4 is switched in descending order when the user operates the operation unit 3 in the downward direction. This structure facilitates the user's search for desired image data.

The operation direction may also determine which order index (e.g., the image taking date/time or the degree of similarity between images composed from image data items) is to be used in switching. To give a concrete example, the image data reproduced on the display unit 4 may be switched in the order of image taking date/time when the user operates the operation unit 3 in the upward direction, whereas the image data reproduced is switched in the order of the degree of similarity between images when the user operates the operation unit 3 in the downward direction. This structure allows the user to select an arbitrary index in a search for desired image data.

The image data reproduced on the display unit 4 may be switched in different methods associated with different general operation directions (for example, the top-bottom direction and the oblique direction) in which the user operates the operation unit 3. To give a concrete example, the image data reproduced may be switched in a given order when the user operates the operation unit 3 in the top-bottom direction, whereas the image data reproduced is switched in an order of another index when the user operates the operation unit 3 in the oblique direction.

The general operation direction and the specific operation direction may respectively determine which order index is to be used and whether this order is an ascending order or a descending order. To give a concrete example, the image data reproduced on the display unit 4 may be switched in ascending order of image taking date/time when the user operates the operation unit 3 in the upward direction, whereas the image data reproduced on the display unit 4 is switched in descending order of image taking date/time when the user operates the operation unit 3 in the downward direction. The image data reproduced on the display unit 4 may be switched in ascending order of the degree of similarity between images when the user operates the operation unit 3 in the oblique upward direction, whereas the image data reproduced on the display unit 4 is switched in descending order of the degree of similarity between images when the user operates the operation unit 3 in the oblique downward direction.

When this action example is applied to the third display example, the same action as when this action example is applied to the second display example may be executed. In this case, the example may be modified such that image data items to which the corresponding images 204 and 205 (see FIG. 7 and FIGS. 10A to 10D) constituting a composite corresponding image correspond are reproduced on the display unit 4. The example may also be modified such that image data items to which the closely correlated corresponding images 203 to 205 (see FIG. 7 and FIGS. 10A to 10D) correspond are reproduced on the display unit 4.

{Post-composite Corresponding Image Selection Action: Second Example}

The display unit 4 in this action example executes the same action as in the first example of the post-composite corresponding image selection action (see FIGS. 20A to 20C). The difference between this action example and the first example is an action executed by the display control unit 5 to switch the image data reproduced on the display unit 4 (action of changing FIG. 20B to FIG. 20C). The rest of this action example is the same as the first example, and a description thereof is omitted.

In this action example, the image data reproduced on the display unit 4 is switched in a given order when the display control unit 5 detects that no instruction has been input from the user via the operation unit 3 for a given period of time or longer. The display control unit 5 can execute the switching repeatedly.

With this structure, the user can easily reproduce and check image data items to which a plurality of closely correlated corresponding images respectively correspond, without needing to perform a special operation.

{Post-composite Corresponding Image Selection Action: Third Example}

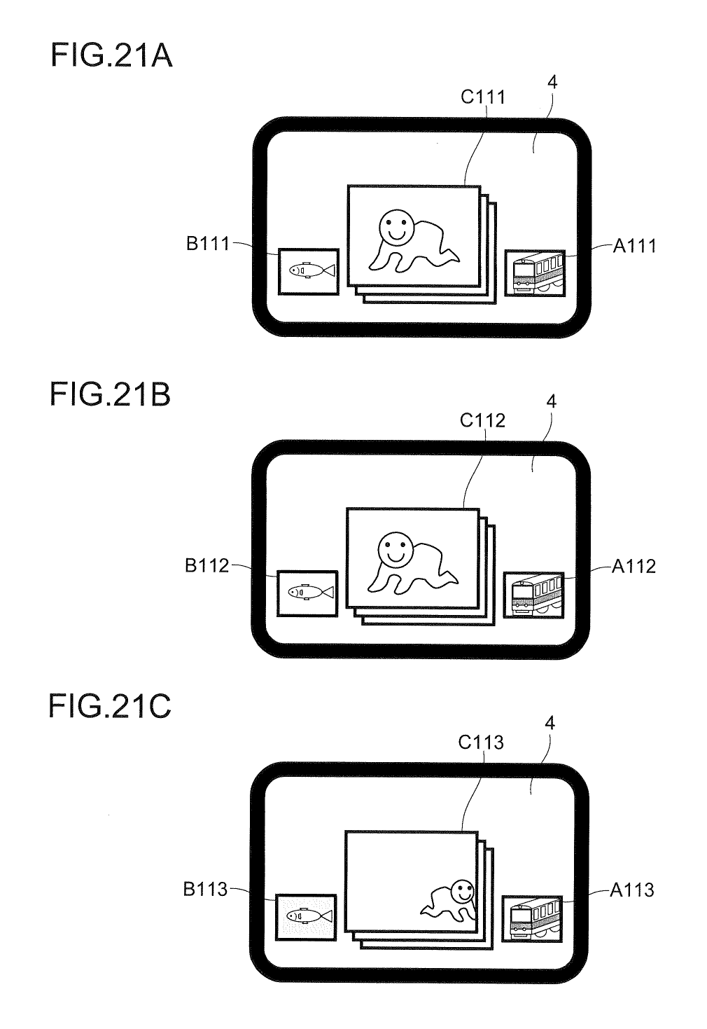

FIGS. 21A to 21C are diagrams illustrating a third example of the post-composite corresponding image selection action, and correspond to the second display example. FIG. 21A is an example of how display by the display unit 4 looks prior to the composite corresponding image selection detection action. FIG. 21B is an example of how display by the display unit 4 looks immediately after the composite corresponding image selection detection action. FIG. 21C is an example of how display by the display unit 4 looks after the user inputs an instruction that is not a switching instruction via the operation unit 3 while the display unit 4 is as shown in FIG. 21B.

As illustrated in FIGS. 21A and 21B, in this action example, the selected composite corresponding image is kept displayed after the display control unit 5 executes the composite corresponding image selection detection action described above. Various adjustments such as enlargement may be made to the composite corresponding image at this point, as long as a preceding candidate image B112 and a next candidate image A112 are at least partially displayed (in other words, as long as the user can see the order of the composite corresponding image and the corresponding images).

While the composite corresponding image is displayed as illustrated in FIG. 21B, the user inputs an instruction that is not a switching instruction via the operation unit 3, thereby causing the display control unit 5 to change display on the display unit 4 such that the representative corresponding image is one of the corresponding images constituting the selected composite corresponding image that is not the former representative corresponding image 205 (see FIG. 7). In the example of FIG. 21C, display on the display unit 4 is changed such that the corresponding image 203 (see FIG. 7) is the representative corresponding image.

Subsequently, the user further inputs an instruction that is not a switching instruction, causing the display control unit 5 to sequentially switch the representative corresponding image of the selected composite corresponding image. The representative corresponding image is switched, for example, in the order of the degree of correlation, the order of the degree of similarity between images, the order of image taking date/time, or other orders described above.

This structure enables the user to check a plurality of corresponding images constituting a composite corresponding image with ease.

The action described in the first example of the post-composite corresponding image selection action, in which the user's operation of the operation unit 3 in a non-switching instruction direction causes the switching of image data reproduced on the display unit 4, may be executed in this action example. However, the image switched in this action example is the representative corresponding image of the selected composite corresponding image.

When this action example is applied to the third display example, the same action as when this action example is applied to the second display example may be executed. In this case, the example may be modified such that how the corresponding images 204 and 205 (see FIG. 7 and FIGS. 10A to 10D) constituting a composite corresponding image are displayed on the display unit 4 can be changed (for example, the order in which the images are arranged or the size of the images can be changed). The example may also be modified such that which of the closely correlated corresponding images 203 to 205 (see FIG. 7 and FIGS. 10A to 10D) is displayed independently, instead of being grouped with the other corresponding images, can be changed by causing the corresponding image 203, which has been displayed independently instead of being grouped together, and the corresponding images 204 and 205, which have constituted a composite corresponding image, to switch places with each other.

{Post-composite Corresponding Image Selection Action: Fourth Example}

The display unit 4 in this action example executes the same action as in the third example of the post-composite corresponding image selection action (see FIGS. 21A to 21C). The difference between this action example and the third example is an action executed by the display control unit 5 to switch the representative corresponding image of a composite corresponding image (action of changing FIG. 21B to FIG. 21C). The rest of this action example is the same as the third example, and a description thereof is omitted.

In this action example, the representative corresponding image of a composite corresponding image is switched in a given order when the display control unit 5 detects that no instruction has been input from the user via the operation unit 3 for a given period of time or longer. The display control unit 5 can execute the switching repeatedly.

With this structure, the user can easily check a plurality of corresponding images constituting a composite corresponding image, without needing to perform a special operation.

{Post-composite Corresponding Image Selection Action: Fifth Example}

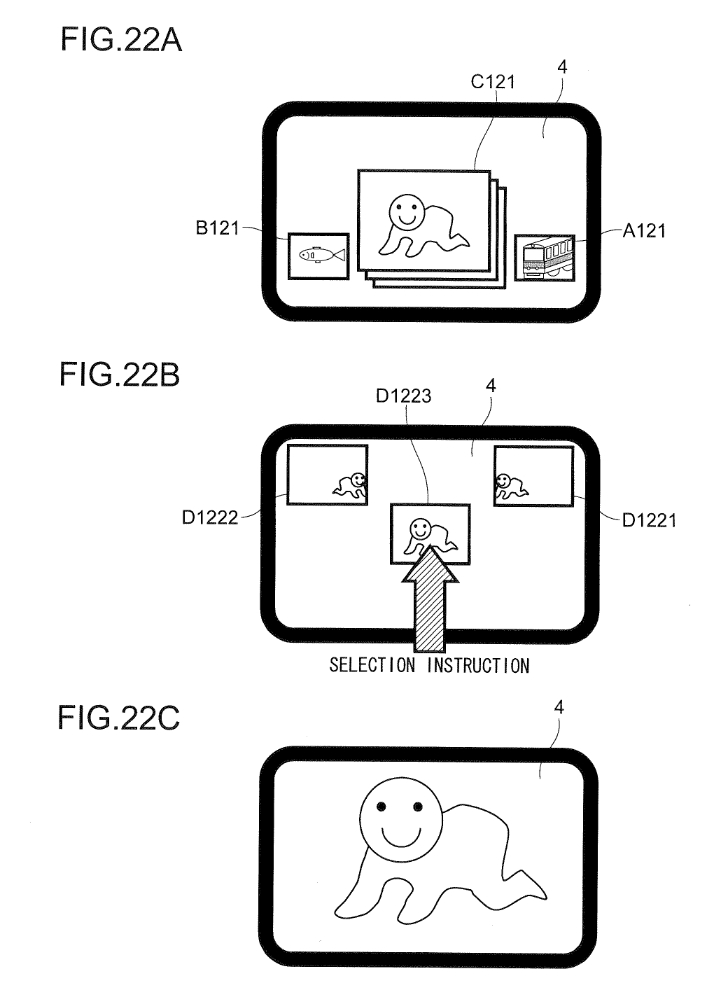

FIGS. 22A to 22C are diagrams illustrating a fifth example of the post-composite corresponding image selection action, and correspond to the second display example. FIG. 22A is an example of how display by the display unit 4 looks prior to the composite corresponding image selection detection action. FIG. 22B is an example of how display by the display unit 4 looks immediately after the composite corresponding image selection detection action action. FIG. 22C is an example of how display by the display unit 4 looks after the user inputs a selection via the operation unit 3 while the display unit 4 is as shown in FIG. 22B.

As illustrated in FIGS. 22A and 22B, in this action example, the closely correlated corresponding images 203 to 205 (see FIG. 7. In this example, corresponding images that constitute a composite corresponding image.) are separately displayed as view-all images D1221 to D1223 when the display control unit 5 executes the composite corresponding image selection detection action described above. In displaying those images, the representative corresponding image 205 (see FIG. 7) of the composite corresponding image which is the view-all image D1223 may be positioned at the center of the display unit 4 or other places where the image will easily be spotted.

While the view-all images D1221 to D1223 are being displayed as illustrated in FIG. 22B, the user inputs a selection instruction via the operation unit 3, and the display control unit 5 reproduces on the display unit 4 image data associated with one of the corresponding images displayed as view-all images that is selected by the selection instruction. In the example of FIG. 22C, the input selection instruction is for selecting the corresponding image 205 (see FIG. 7) which is the view-all image D1223, and image data to which the corresponding image 205 corresponds is reproduced on the display unit 4.

With this structure, corresponding images that have a close correlation with one another can easily be checked at once.

In the case where the user inputs a given instruction (for example, a selection instruction for selecting an arbitrary area on the display unit 4) while the display unit 4 is reproducing image data as in FIG. 22C, the display control unit 5 may display corresponding images and a composite corresponding image on the display unit 4 as in FIG. 22A, or may display view-all images on the display unit 4 as in FIG. 22B.

In the case where the display unit 4 is as shown in FIG. 22B and the user inputs via the operation unit 3 a selection instruction for selecting an area that contains none of the view-all images D1221 to D1223, the display control unit 5 may display on the display unit 4 corresponding images and a composite corresponding image as in FIG. 22A.

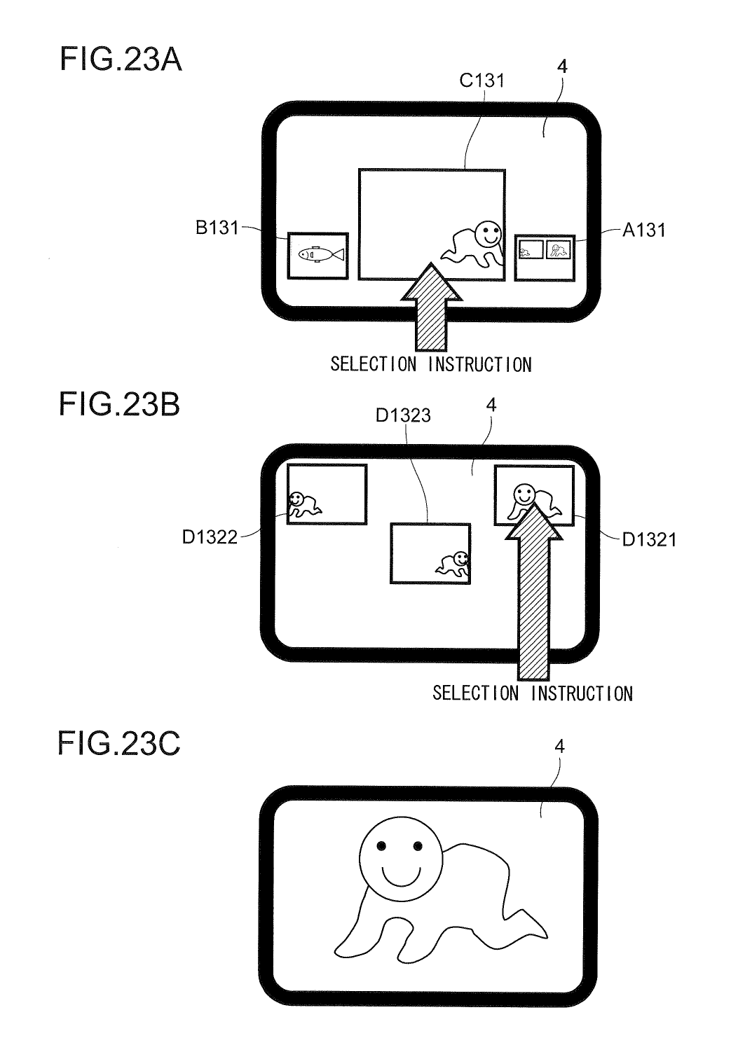

When this action example is applied to the third display example, the same action as when this action example is applied to the second display example may be executed. In this case, the closely correlated corresponding images 203 to 205 (see FIG. 7) may be displayed on the display unit 4 as view-all images as in FIG. 23B, or only the corresponding images 204 and 205 which constitute a composite corresponding image (see FIG. 7 and FIGS. 10A to 10D) may be displayed on the display unit 4 as view-all images.

[Modification Examples of the Actions]

{First Modification Example}

In the case where the action examples described above are applied to the third display example, the action executed in response to the user's selection of the corresponding image 203 (see FIG. 7 and FIGS. 10A to 10D), which has a close correlation with the corresponding images 204 and 205 (see FIG. 7 and FIGS. 10A to 10D) but is not displayed as part of a composite corresponding image constituted of the corresponding images 204 and 205, may be the same as when the composite corresponding image is selected. The corresponding image 203 which is not displayed as part of the composite corresponding image may also be interpreted as an equivalent of the representative corresponding image in the second display example and the fourth display example.

A concrete description is given with reference to the drawings on an example of this action. FIGS. 23A to 23C are diagrams illustrating a first modification example of the action executed when the selected image is a composite corresponding image, and correspond to the third display example. FIG. 23A is an example of how display by the display unit 4 looks prior to the composite corresponding image selection detection action. FIG. 23B is an example of how display by the display unit 4 looks immediately after the composite corresponding image selection detection action. FIG. 23C is an example of how display by the display unit 4 looks after the user inputs a selection instruction via the operation unit 3 while the display unit 4 is as shown in FIG. 23B.

In this modification example, as illustrated in FIGS. 23A and 23B, the display control unit 5 displays view-all images D1321 to D1323 of the corresponding images 203 to 205 on the display unit 4 even when the input selection instruction is for selecting the corresponding image 203 (reproduction candidate image C131, see FIG. 7), which has a close correlation with the corresponding images 204 and 205 (see FIG. 7) but is not displayed as part of a composite corresponding image (next candidate image A131) constituted of the corresponding images 204 and 205. Subsequently, the same action as in the fifth example of the post-composite corresponding image selection action is executed as illustrated in FIGS. 23B and 23C.

With this structure, the user can easily check corresponding images that have a close correlation to one another at once by selecting at least one of the closely correlated corresponding images.

This modification example corresponds to the second example of the composite corresponding image selection detection action and the fifth example of the post-composite corresponding image selection action, but can be adapted so as to correspond to other action examples as well.

{Second Modification Example}

The corresponding image that is displayed preferentially, such as the representative corresponding image in the second and fourth display examples or a corresponding image that has a close correlation with corresponding images constituting a composite corresponding image but is not displayed as part of the composite corresponding image in the third display example, may be variable. For instance, the corresponding image that is displayed preferentially may be one that has most recently been selected by the user, such as a corresponding image of image data most recently reproduced by the user, or a corresponding image most recently displayed preferentially in the third example of the post-composite corresponding image selection action.

This structure enables the image display device 1 to preferentially display a corresponding image that is likely to be selected by the user. Selecting a desired corresponding image is thus made easy for the user.

{Third Modification Example}

The display control unit 5 may additionally display operation methods of the operation unit 3 on the display unit 4 when a corresponding image and a composite corresponding image are displayed, when view-all images are displayed, when image data is reproduced, or the like. An example of how display by the display unit 4 looks in this case is described with reference to the drawings.

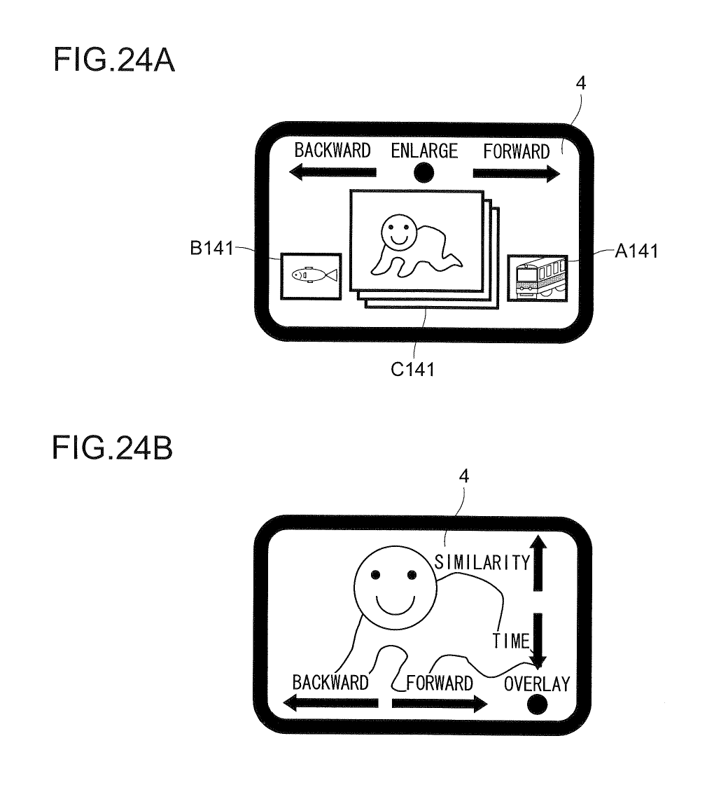

FIGS. 24A and 24B are diagrams illustrating a third modification example of the action executed when the selected image is a composite corresponding image, and correspond to the second display example. FIG. 24A is an example of how display by the display unit 4 looks when corresponding images and a composite corresponding image are displayed. FIG. 24B is an example of how display by the display unit 4 looks when image data is reproduced.

As illustrated in FIG. 24A, the display unit 4 displays images that indicate operation methods for giving a switching instruction (leftward arrow with “backward” and rightward arrow with “forward” in the drawing), and images that indicate operation methods for giving a selection instruction (black circle with “enlarge” in the drawing).

As illustrated in FIG. 24B, the display unit 4 displays images that indicate operation methods for giving a switching instruction (leftward arrow with “backward” and rightward arrow with “forward” in the drawing), images that indicate operation methods for giving a selection instruction (black circle with “overlay” in the drawing), and images that indicate other instructions than a switching instruction (upward arrow with “similarity” and downward arrow with “time”).

This structure allows the user to operate the operation unit 3 while looking at the images indicating operation methods that are displayed on the display unit 4. The user can thus easily bring the display unit 4 to a desired state.

The images indicating operation methods may be displayed on the display unit 4 all the time, or may be displayed only when a given condition is met, such as when the user operates the operation unit 3. This modification example corresponds to the second example of the composite corresponding image selection detection action and the first example of the post-composite corresponding image selection action, but can be adapted so as to correspond to other action examples as well. This modification is applicable not only to cases where a composite corresponding image is displayed (e.g., the second to fourth display examples) but also to cases where a composite corresponding image is not displayed (e.g., the first display example). However, this modification example is more effective when applied to cases where a composite corresponding image is displayed and accordingly the operation of the operation unit 3 may become complicated (e.g., the second and third examples of the composite corresponding image selection detection action and the first, third, and fifth examples of the post-composite corresponding image selection action).

When the user inputs a switching instruction via the operation unit 3 while the display unit 4 is reproducing image data as in the display example of FIG. 24B, the switching action described above is executed. Specifically, in the case where the state of FIG. 24B is one reached by, for example, inputting a selection instruction for selecting a reproduction candidate image C141 of FIG. 24A, when the user inputs a switching instruction (for going forward) via the operation unit 3, the display control unit 5 reproduces on the display unit 4 image data associated with the corresponding image 206 (see FIG. 7), which is a next candidate image A141. The display control unit 5 may also cause the display unit 4 to display a state (where the corresponding image 206 (see FIG. 7) is the reproduction candidate image) reached after going forward in FIG. 24A in the manner described above. The same switching action may be executed also when a switching instruction is input while the display unit 4 is displaying view-all images.

<<Modification Example>>

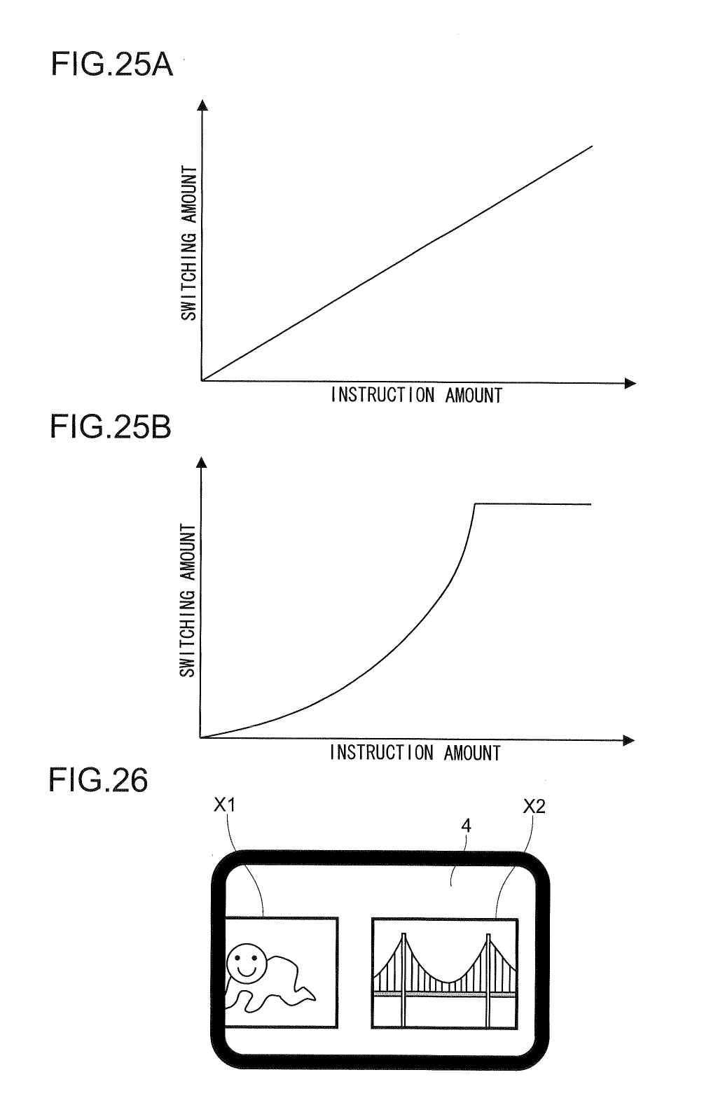

In the description given above, the switching amount takes only an integer value so that corresponding images are switched on an image basis. Alternatively, the switching amount may be set to a decimal number so that corresponding images are switched on a partial-image basis. An example of this case is described with reference to the drawings. FIGS. 25A and 25B are graphs showing other examples of the basic relation between the instruction amount and the switching amount, and correspond to FIGS. 3A and 3B. FIG. 26 is a diagram illustrating another example of how display by the display unit looks in a search for image data to be reproduced, and corresponds to FIGS. 2A to 2C.

As shown in FIGS. 25A and 25B, a graph of the basic relation in this example takes continuous values. For instance, in the graph of FIG. 25A, the switching amount increases linearly as the instruction amount increases. In the graph of FIG. 25B, on the other hand, the switching amount increases non-linearly as the instruction amount increases. The switching amount in the graph of FIG. 25A does not have an upper limit, whereas the switching amount in the graph of FIG. 25B has an upper limit and becomes constant after the instruction amount reaches a certain value. FIGS. 25A and 25B are merely examples, and the relation between the instruction amount and the switching amount can be other than the basic relation shown in FIGS. 25A and 25B. For instance, an upper limit may be set to the switching amount in the graph of FIG. 25A, and an upper limit may not be set to the switching amount in the graph of FIG. 25B.

FIG. 26 illustrates an example of how display by the display unit 4 looks when the switching amount is set in the manner described above. In FIG. 26, a corresponding image X1 which has been the reproduction candidate image prior to a switch is partially moved to go forward, and a corresponding image X2 which follows the corresponding image X1 in the order is about to become a new reproduction candidate image. In this state, neither of the corresponding images X1 and X2 may be regarded as a reproduction candidate image, or one of the corresponding images X1 and X2 may be regarded as the reproduction candidate image.

The switching amount which is defined in the description given above as the number of corresponding images switched per switching action may be defined as the number of corresponding images switched per unit time. Defined as this, the switching amount is interpreted as a speed at which corresponding images are switched, and images are switched faster as the instruction amount increases (for example, corresponding images seemingly move fast on the display unit 4 to be switched). The switching speed during a switching action is not limited to a constant speed. For instance, when a plurality of corresponding images are to be switched at once, the switching speed may be increased for corresponding images that are switched nearer to the end of this switching action.

In some cases, the switching amount per unit time is inevitably increased as a result of increasing the switching amount per unit action, or the switching amount per unit action is inevitably increased as a result of increasing the switching amount per unit time. Those cases include the first display example when the length of one switching action is limited to a given range, and the second to fourth display examples.

In the image display device 1 according to the embodiment of the present invention, the actions executed by the display control unit 5 and the actions of other components may be implemented by a control device such as a microcomputer. Further, all or some of functions implemented by the control device may be written as a program so that all or some of the functions are implemented by running the program on a program executing device (e.g., a computer).

The image display device 1 of FIG. 1 is not limited to those adaptations and can be implemented by hardware or a combination of hardware and software. In the case where software is a component of the image display device 1, the block of a part implemented by the software represents the function block of the part.

The embodiment of the present invention has now been described. The present invention, however, is not limited thereto and can be carried out with various modifications, without departing from the spirit of the present invention.

The present invention is applicable to an image display device for displaying an image, typically, a display unit of an imaging device or a viewer, and to an image display method.

What is claimed is:

1. An image display device, comprising:
a display unit which displays at least one of corresponding images which are in a given order;
an input unit to which a switching instruction is input to switch the at least one corresponding image displayed on the display unit in the given order: and
a switching control unit which switches the at least one corresponding image displayed on the display unit in accordance with the switching instruction,
wherein, when the at least one corresponding image displayed on the display unit does not have a close correlation with at least a corresponding image to be displayed next, the switching control unit switches the corresponding images by a first switching amount, which is determined based on the switching instruction, and
wherein, when the correlation is close, the switching control unit switches the corresponding images by a second switching amount, which is determined by a method different from that of the first switching amount.

2. An image display device according to claim 1,
wherein the first switching amount and the second switching amount each indicate a number of corresponding images switched per unit action or per unit time, and
wherein the second switching amount that is set when a given switching instruction is input is equal to or larger than the first switching amount that is set when the given switching instruction is input.

3. An image display device according to claim 2,
wherein the switching instruction indicates an instruction amount and the first switching amount increases as the instruction amount increases, and
wherein the second switching amount equals the first switching amount when the switching instruction input to the input unit indicates an instruction amount that is equal to or smaller than a given amount.

4. An image display device according to claim 1, wherein the display unit displays at least two corresponding images that have a close correlation as one corresponding image into which the at least two corresponding images are grouped together.

5. An image display device according to claim 4,
wherein the display unit reproduces image data to which a selected corresponding image corresponds,
wherein, when at least one of a plurality of corresponding images having a close correlation is selected and the display unit consequently reproduces image data to which one of the plurality of corresponding images corresponds, in response to an input of an instruction through the input unit that is not a switching instruction, or in response to absence of an instruction input to the input unit for a given period of time or longer, the display unit shifts to reproduction of image data to which one of the plurality of corresponding images corresponds and which is not currently reproduced.

6. An image display device according to claim 4,
wherein the display unit gives priority to one of a plurality of corresponding images having a close correlation over the other corresponding images of the plurality of corresponding images, and displays the one corresponding image preferentially,
wherein, in response to an input of an instruction through the input unit that is not a switching instruction, or in response to absence of an instruction input to the input unit for a given period of time or longer, the display unit shifts to preferential display of one of the plurality of corresponding images that is not the currently preferentially displayed corresponding image.

7. An image display device according to claim 4,
wherein the display unit gives priority to one of a plurality of corresponding images having a close correlation over the other corresponding images of the plurality of corresponding images, and displays the one corresponding image preferentially, and
wherein the corresponding image preferentially displayed by the display unit is one of the plurality of corresponding images that has most recently been selected.

8. An image display device according to claim 4, wherein, when at least one of a plurality of corresponding images having a close correlation is selected, the display unit displays the plurality of corresponding images separately.

9. An image display device according to claim 1, wherein a corresponding image is selected in response to an input of an instruction through the input unit that is not a switching instruction, or in response to absence of an instruction input to the input unit for a given period of time or longer.

10. An image display device according to claim 1, wherein the display unit displays an image that indicates an operation method of the input unit.

11. An image display device according to claim 1,
wherein the corresponding images are images corresponding to pieces of image data that are obtained by image taking, and
wherein whether the correlation between the corresponding images is close or not is determined based on at least one of: similarity or dissimilarity between images composed from the pieces of image data; a time difference between image taking dates/times of the pieces of image data; and a distance difference between image taking locations of the pieces of image data.

12. An image display method, comprising:
a first step of displaying at least one of corresponding images which are in a given order;
a second step of inputting a switching instruction which switches the at least one corresponding image displayed in the first step in the given order; and
a third step of switching the at least one corresponding image displayed in the first step,
wherein, when the at least one corresponding image displayed in the first step does not have a close correlation with at least a corresponding image to be displayed next, the corresponding images are switched in the third step by a first switching amount, which is determined based on the switching instruction input in the second step, and
wherein, when the correlation is close, the corresponding images are switched in the third step by a second switching amount, which is determined by a method different from that of the first switching amount.
